(19) United States
(12) Patent Application Publication
(10) Pub. No.: US 2007/0010984 A1
(43) Pub. Date: Jan. 11, 2007

(54) CAE Analysis Navigation System, CAE Analysis Processing Program, and Recording Medium Recording CAE Analysis Processing Program

(76) Inventors: Hirokazu Nishiura, Kyoto (JP); Taiji Nemoto, Kyoto (JP); Jun Ando, Kyoto (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 10/554,502

(22) PCT Filed: Feb. 25, 2005
(86) PCT No.: PCT/JP05/03150

§ 371 Date: Oct. 26, 2005

(30) Foreign Application Priority Data
Feb. 26, 2004 (JP) 2004-052104
Jun. 28, 2004 (JP) 2004-190218

(51) Int. Cl. G06F 9/45

(52) U.S. Cl. 703/22

(57) ABSTRACT

A CAE analysis navigation system in which a plurality of terminal apparatuses 10 storing an analysis procedure of CAE analysis as a program are connected via a communication network, is provided. The terminal apparatus 10 comprises a display section of displaying an analysis procedure screen for an object, a general-purpose analysis procedure file section 62a of storing a general-purpose analysis procedure program in which a procedure of CAE analysis applied in common to various analysis objects is navigated, and a computation section 61 of executing analysis calculation with respect to a specific object based on the general-purpose analysis procedure program stored in the general-purpose analysis procedure file section 62a. The plurality of terminal apparatuses 10 perform the analysis procedure of the CAE analysis with respect to an analysis object in accordance with separate entries through the terminal apparatuses 10, simultaneously and in association with each other via the communication network.

### TECHNICAL FIELD

The present invention relates to a CAE analysis navigation system, a CAE analysis processing program, and a recording medium recording a CAE analysis processing program for use in the fields of computer simulation which can be used for strength analysis, flow analysis or the like of products, and computer simulation which aids design for improvement of product quality.

### BACKGROUND ART

When CAE analysis technology is used to design various products, experts on the analysis conventionally perform complicated strength calculation or the like to design the products. Specifically, since CAE analysis is based on physical laws expressed with differential equations, the user needs to understand the differential equations and mathematical rules inevitably required for numerical analysis. Therefore, not everyone can easily perform CAE analysis.

Techniques for improving the operability of CAE analysis as well as other various analyses have been proposed.

For example, a navigation system which stores an operational procedure of analysis, and based on the stored contents, automatically performs the analysis, has been proposed (see, for example, Patent Publication 1). Thereby, it is possible to eliminate time and trouble in repeating the same operational procedure for each time of analysis, leading to an improvement in operability of the analysis.

However, in individually tailored navigation systems, such as that described in Patent Publication 1, navigation is previously optimized for each product, and analysis know-how is also previously described, and typically, they cannot be, for example, subsequently changed, resulting in less general versatility. Although the individually tailored navigation system is considerably easy to use and does not require the know-how to use, it takes a long time to produce the software, resulting in considerably high cost.

The present applicant has already proposed a general-purpose analysis system which solves the above-described problems (see, for example, Patent Publication 2). The general-purpose analysis system stores a procedure of CAE analysis as a program, and comprises display means for displaying an analysis procedure screen for an object, general-purpose analysis procedure program storing means for storing a general-purpose analysis procedure program which is applied in common to various analysis objects, analysis know-how description screen display program storing means for storing a screen display program related to an analysis know-how description, the screen display program allowing the display means to display an analysis know-how description screen on which analysis know-how specific to an analysis object is described, analysis know-how storing means for storing analysis know-how on a specific object, the analysis know-how being described on the analysis know-how description screen, and analysis calculation means for executing analysis calculation with respect to a specific object based on the general-purpose analysis procedure program stored in the general-purpose analysis procedure program storing means and the analysis know-how on the specific object which is stored in the analysis know-how storing means. The general-purpose analysis procedure program includes at least a step of producing a mesh, a step of defining a material, and a step of setting a boundary condition. The analysis know-how description screen is linked to entry screens corresponding to the respective steps. Analysis know-how corresponding to each step for a specific object previously stored in the analysis know-how storing means is directly displayed on the analysis know-how description screen.

According to the invention of Patent Publication 2, any one who is not an expert on analysis can easily and correctly perform CAE analysis.

[Patent Publication 1] JP H10-303267 A

[Patent Publication 2] JP 3382934

### DISCLOSURE OF INVENTION

### Problems to be Solved by the Invention

An object of the present invention is to provide a CAE analysis navigation system, a CAE analysis processing program, and a recording medium recording the CAE analysis processing program which can provide a higher level of general versatility and a more flexible usable form of CAE analysis.

### Means for Solving the Problems

A CAE analysis navigation system of the present invention has a system structure in which a plurality of terminal apparatuses storing an analysis procedure of CAE analysis as a program are connected via a communication network. The plurality of terminal apparatuses perform the analysis procedure of the CAE analysis with respect to an analysis object in accordance with separate entries through the terminal apparatuses, simultaneously and in association with each other via the communication network, and have a support function to reciprocally support an analysis task. In this case, the terminal apparatus comprises display means for displaying an analysis procedure screen for an object, general-purpose analysis procedure program storing means for storing a general-purpose analysis procedure program which navigates the analysis procedure of the CAE analysis applied in common to various analysis objects, and analysis calculation means for executing analysis calculation with respect to a specific object based on the general-purpose analysis procedure program stored in the general-purpose analysis procedure program storing means. Note that the general-purpose analysis procedure program storing means may be provided on the communication network, and each terminal apparatus accesses the network to obtain a required analysis procedure programs.

A CAE analysis processing program of the present invention is a computer readable program which stored in a plurality of terminal apparatuses interconnected via a communication network, an analysis procedure of CAE analysis applied in common to a common analysis object being successively performed by the plurality of terminal apparatuses, simultaneously and in association with each other. The analysis procedure includes an analysis object model producing step, a mesh refining step, a material selecting step, a condition setting step of setting a condition, depending on analysis contents, and an analysis performing step, and further, a step of transmitting processing information to the other terminal apparatuses to have in common a process of each of the steps among the terminal apparatuses, and a step of reflecting processing information transmitted from the other terminal apparatuses in a process of the self apparatus. The analysis procedure further includes a step of having in common support information about an analysis task corresponding to each of the steps among the terminal apparatuses via an electronic notice board.

Note that the CAE analysis processing program can be provided, stored in various recording media, such as magnetic disks (e.g., FD (flexible disk), HD (hard disk), etc.), optical discs (e.g., CD-ROM, MO, MD, DVD, etc.), cards (e.g., IC card, optical card, etc.), semiconductor memories (masked ROM, EPROM, EEPROM, flash ROM, etc.), and the like.

### EFFECTS OF THE INVENTION

In the CAE analysis navigation system of the present invention, a plurality of terminal apparatuses interconnected via a communication network perform CAE analysis with respect to the same single analysis object simultaneously and in association with each other, thereby making it possible for the operators of the terminal apparatuses to have in common an analysis status of the same object in real time. Therefore, when the operator of one terminal apparatus is a person having little experience of CAE analysis, but the operators of the other terminal apparatuses are experts on the CAE analysis, the experts can confirm a task procedure of the CAE performed by the inexperienced operator in real time, thereby making it possible to preliminarily detect an error in a condition setting and eliminate waste, such as returning to a previous task.

According to the CAE analysis navigation system of the present invention, a CAE analysis task with respect to one analysis object can be shared by the terminal apparatuses. For example, only production of a model geometry of an analysis object may be taken charge of by the operator of the terminal apparatus A, and subsequent setting of various definitions and conditions may be taken charge of the operator of the terminal apparatus B. Analysis may be performed by both the operators of the terminal apparatuses A and B after the operator of either of the terminal apparatuses A and B issues an instruction to perform the analysis. The operators A and B refer to results of analysis of the respective terminal apparatuses. Thus, task sharing can be performed.

The CAE analysis navigation system of the present invention has a support function to reciprocally support an analysis task. Therefore, the support function can be used to provide communication between operators as required during the process of CAE analysis. For example, an operator having little experience of analysis asks a question to an experienced operator, and the experienced operator answers to the question. Here, the support function includes at least one piece of information among audio information, character information, and image information including a moving image. For example, an electronic notice board which provides character information is utilized as the support function.

According to the CAE analysis navigation system of the present invention, the display means may display a model screen for displaying a model of an analysis object, and a menu screen. A display size of the menu screen may be changeable. Thereby, the display size of the menu screen can be changed by the operator as required, thereby making it possible to consistently maintain an appropriate size of the model screen for displaying a model of an analysis object.

The menu screen may be superposed as a transparent window or a semi-transparent window on the model screen in a manner which allows the model screen to perform display. In this case, various tasks can be performed while an analysis object can be displayed on a large screen without being blocked by the menu screen. Further, the menu screen is separably provided on the model screen. Thereby, the operability for the operator is further improved.

According to the CAE analysis processing program of the present invention, a processing step in one terminal apparatus can be reflected in other terminal apparatus(es), whereby CAE analysis can be performed with respect to the same analysis object simultaneously and in parallel in the terminal apparatuses. Further, a support function (e.g., an electronic notice board) can be used to provide communication between operators as required during the process of CAE analysis. For example, an operator having little experience of analysis asks a question to an experienced operator, and the experienced operator answers to the question.

### BRIEF DESCRIPTION OF DRAWINGS

FIG. 1 is a schematic diagram illustrating a system structure of a CAE analysis navigation system according to an embodiment of the present invention.

FIG. 2 is a block diagram conceptually illustrating an embodiment of a terminal apparatus in the CAE analysis navigation system of FIG. 1.

FIG. 3 is a diagram for explaining an exemplary basic arrangement of a model screen and a menu screen displayed on a display section.

FIG. 4 is a diagram for explaining an exemplary initial screen when a database is opened.

FIG. 5 is a diagram for explaining an exemplary analysis type selection screen.

FIG. 6 is a diagram for explaining an exemplary case number entry screen of a boundary condition.

FIG. 7 is a diagram for explaining an exemplary analysis procedure display screen in the case of structural analysis.

FIG. 8 is a diagram for explaining an exemplary analysis model selection screen.

FIG. 9 is a diagram for explaining an exemplary geometry production screen.

FIG. 10 is a diagram for explaining an exemplary CAD file selection screen.

FIG. 11 is a diagram for explaining an exemplary CAD file selection screen.

FIG. 12 is a diagram for explaining an exemplary CAD file selection screen.

FIG. 13 is a diagram for explaining an exemplary model confirmation screen.

FIG. 14 is a diagram for explaining an exemplary analysis procedure display screen.

FIG. 15 is a diagram for explaining an exemplary mesh refinement screen.

FIG. 16 is a diagram for explaining an exemplary screen for setting a fixing condition in a terminal apparatus.

FIG. 17 is a diagram for explaining an exemplary screen for setting a fixing condition in a terminal apparatus.

FIG. 18 is a diagram for explaining an exemplary display screen of a terminal apparatus which has received face fixation information.

FIG. 19 is a diagram for explaining an exemplary screen in a situation where contents are edited in a terminal apparatus.

FIG. 20 is a diagram for explaining an exemplary display screen of a terminal apparatus which has received corrected face fixation information.

FIG. 21 is a diagram for explaining an exemplary analysis procedure display screen in the case of flow analysis.

FIG. 22 is a diagram for explaining an exemplary screen for setting a forming condition in a terminal apparatus.

FIG. 23 is a diagram for explaining an exemplary screen for setting a forming condition in a terminal apparatus.

FIG. 24 is a diagram for explaining an exemplary display screen of a terminal apparatus which has received filling time information.

FIG. 25 is a diagram for explaining an exemplary analysis procedure display screen in the case of heat analysis.

FIG. 26 is a diagram for explaining an exemplary screen for setting a boundary condition in a terminal apparatus.

FIG. 27 is a diagram for explaining an exemplary screen for setting a boundary condition in a terminal apparatus.

FIG. 28 is a diagram for explaining an exemplary display screen of a terminal apparatus which has received face and face temperature information.

FIG. 29 is a diagram for explaining a degree of freedom of an analysis task procedure.

### DESCRIPTION OF REFERENCE NUMERALS

1 display section

2 entry section

3 screen display program storing section

4 analysis know-how storing section

5 analysis calculation processing section

6 prepost

61 computation section

62 analysis information file section

63 analysis result file section

7 network I/F

8 interactive control section

81 general-purpose analysis procedure file section

82 analysis know-how input/output section 82

9 host computer

10 (10A, 10B, 10C) terminal apparatus

208 setting history screen (electronic notice board)

209 chat screen (electronic notice board)

N communication network

### DESCRIPTION OF THE INVENTION

Hereinafter, embodiments of the present invention will be described with reference to the accompanying drawings.

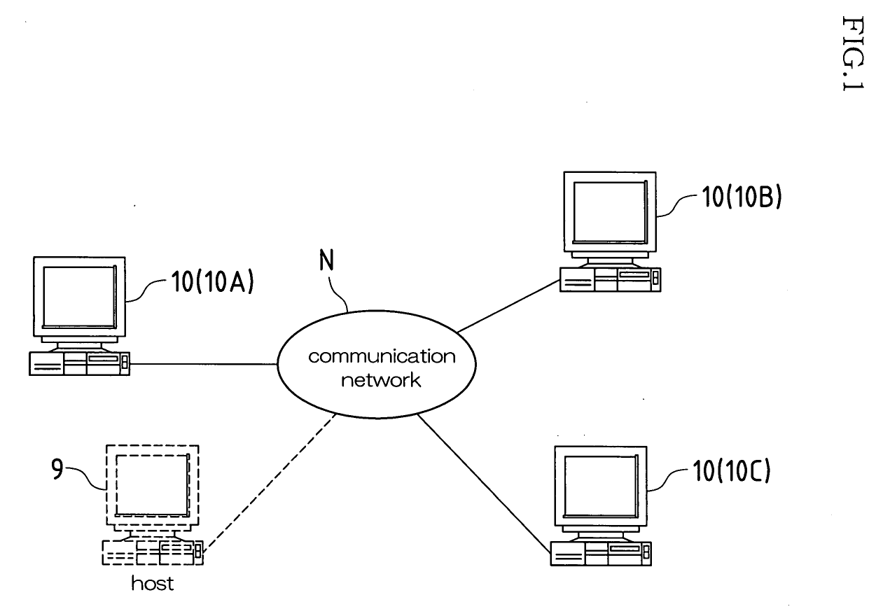

FIG. 1 is a schematic diagram illustrating a system structure of a CAE analysis navigation system according to an embodiment of the present invention.

In the CAE analysis navigation system of the embodiment of the present invention, a plurality of terminal apparatus 10 (10A, 10B, 10C, . . . ) which store an analysis procedure of CAE analysis as a program are connected to each other via a communication network N.

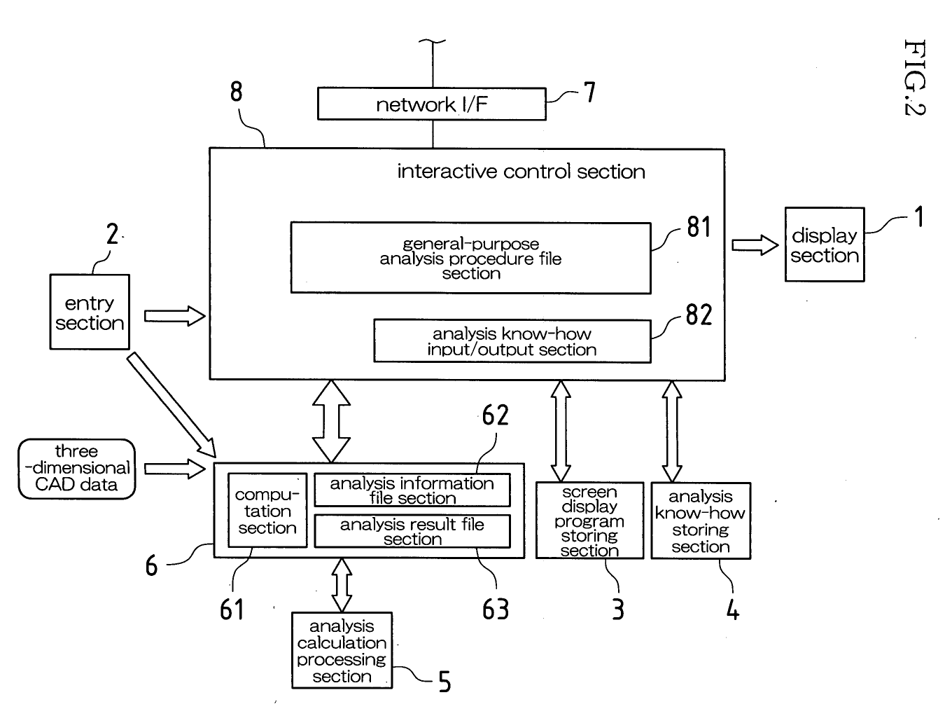

FIG. 2 is a block diagram conceptually illustrating an embodiment of the terminal apparatus 10 in the CAE analysis navigation system of FIG. 1.

The terminal apparatus 10 roughly comprises: a display section 1 of displaying an analysis procedure screen or an analysis know-how screen for an object; an entry section 2 including a mouse, a keyboard, or the like which is used when operating any item on an analysis procedure screen displayed on the display section 1; a screen display program storing section 3 of storing an analysis procedure screen display program for successively displaying analysis procedure screens on the display section 1 in accordance with an operation of the entry section 2, and an analysis know-how screen display program for operating any item on each analysis procedure screen displayed on the display section 1 using the entry section 2 to display an analysis know-how screen corresponding to the item on the display section 1; an analysis know-how storing section 4 of storing analysis know-how of a specific object which is described on an analysis know-how screen displayed on the display section 1; an analysis calculation processing section (analysis solver) 5 of performing analysis in accordance with information input through the entry section 2; a prepost 6 and an interactive control section 8 which perform a control and a computation of each section; and a network interface (network I/F) 7 for reciprocally connecting to other terminal apparatus 10 via the communication network N.

The prepost 6 comprises a computation section 61, an analysis information file section 62, and an analysis result file section 63. The computation section 61 is a section which calculates element geometry or element division in actual analysis. The analysis information file section 62 is a section for accumulating information on an analysis object which is input on each entry screen through the entry section 2 or from three-dimensional CAD data. The analysis result file section 63 is a section which accumulates a result of analysis.

The interactive control section 8 comprises a general-purpose analysis procedure file section 81 which stores a general-purpose analysis procedure program which is applied in common to analysis objects, and an analysis know-how input/output section 82.

The analysis calculation processing section 5 performs analysis calculation with respect to a specific object based on the analysis information file section 62 of the prepost 6. Therefore, the analysis calculation processing section 5 is equipped with various analysis software (not shown) called as analysis solvers which perform analysis of an object (e.g., software for structural analysis, heat conduction analysis, flow analysis, magnetic field analysis, impact analysis, vibration analysis, etc.).

The interactive control section 8, when performing analysis, performs a process of successively displaying analysis information entry screens on the display section 1 in accordance with a program stored in the screen display program storing section 3, and accumulates analysis information input on the entry screens into the analysis information file section 62 of the prepost 6. The interactive control section 8 also accumulates into the analysis result file section 63 a result of analysis of an object which is performed by the analysis calculation processing section 5 based on analysis information stored in the analysis information file section 62. Note that the analysis know-how screen is not a major part of the present invention and will not be explained.

The interactive control sections 8 perform the analysis procedure of CAE analysis simultaneously and in association with each other via the communication network N and the network I/F 7, with respect to an analysis object, based on inputs separately obtained through the entry sections 2 of the respective terminal apparatuses, and have a support function to reciprocally support the analysis task. The support function includes at least one piece of information among audio information, character information, and image information including a moving image. For example, an electronic notice board which provides character information is utilized as the support function.

In the above-described embodiment, the general-purpose analysis procedure file section 81 which stores a general-purpose analysis procedure program which is applied in common to various analysis objects, is stored in the interactive control section 8. Alternatively, the general-purpose analysis procedure file section 81 may be stored in a host computer 9 which is provided on and is connected to the communication network N as illustrated with a dashed line in FIG. 1. In this case, when performing analysis, each terminal apparatus 10 connects to the host computer 9 and installs the general-purpose analysis procedure program. After performing analysis, the general-purpose analysis procedure program is uninstalled as required.

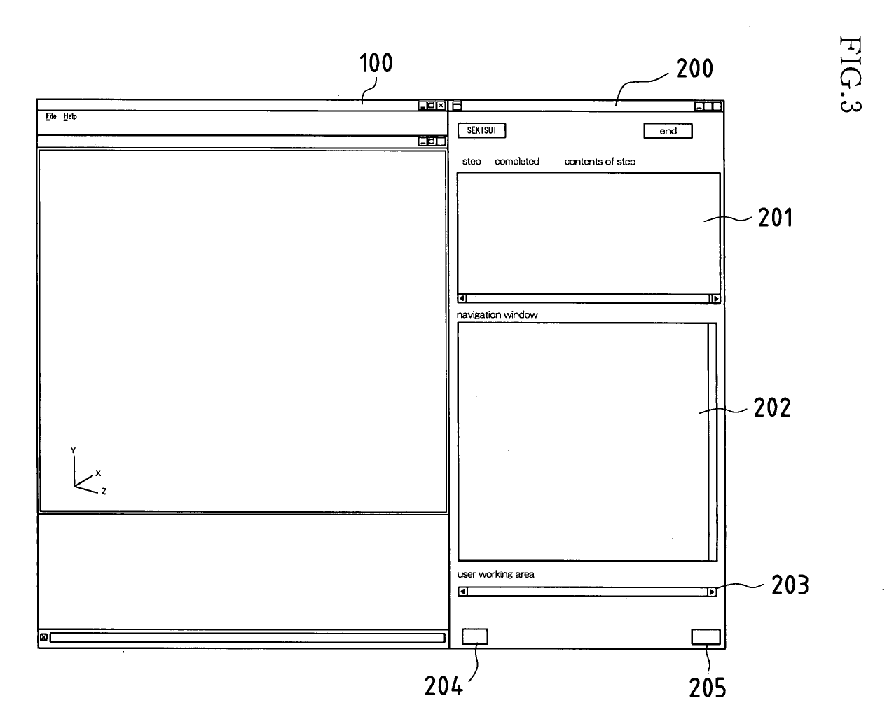

FIG. 3 illustrates an exemplary basic arrangement of a model screen 100 which displays geometry models of analysis objects successively displayed on the display section 1 in accordance with the entry screen display program stored in the screen display program storing section 3, in accordance with an input operation through the entry section 2, and a menu screen 200 which displays an analysis procedure. Basically, various menu screens 200 are provided on a right-hand side of the model screen 100.

The menu screen 200 is basically composed of three parts. The upper part is a step display window 201 for displaying to what stage an operation of an analysis procedure has proceeded. The middle part is a display window (navigation window) 202 for displaying contents of the analysis procedure. The lower part is an entry window 203 for entering various numerical values, characters, or the like.

Here, the general-purpose analysis procedure program starts with a step of opening a database, and includes steps (procedure), i.e., a geometry producing step, a mesh refining step, a material characteristic value setting step, a condition setting step depending on analysis contents, an analysis performing step, and a result displaying step. In the embodiment, a plurality of the terminal apparatuses 10A, 10B, and 10C can be connected to each other via the communication network N. Therefore, the general-purpose analysis procedure program also includes an information transmitting step of transmitting processing information in each step to other terminal apparatuses to have in common the process in each step between the terminal apparatuses, an editing step of reflecting processing information transmitted from other terminal apparatuses in its own process, and a step of having in common support information for an analysis task corresponding to a process in each step among terminal apparatuses via, for example, an electronic notice board, in order that the process in each step is processed in common among terminal apparatuses.

Next, a basic operation of CAE analysis performed by the CAE analysis navigation system thus constructed will be briefly described before a processing operation of CAE analysis according to the embodiment of the present invention will be described, and thereafter, examples of support, education, or the like of an analysis task using a network will be described.

### Description of Basic Operation of CAE Analysis

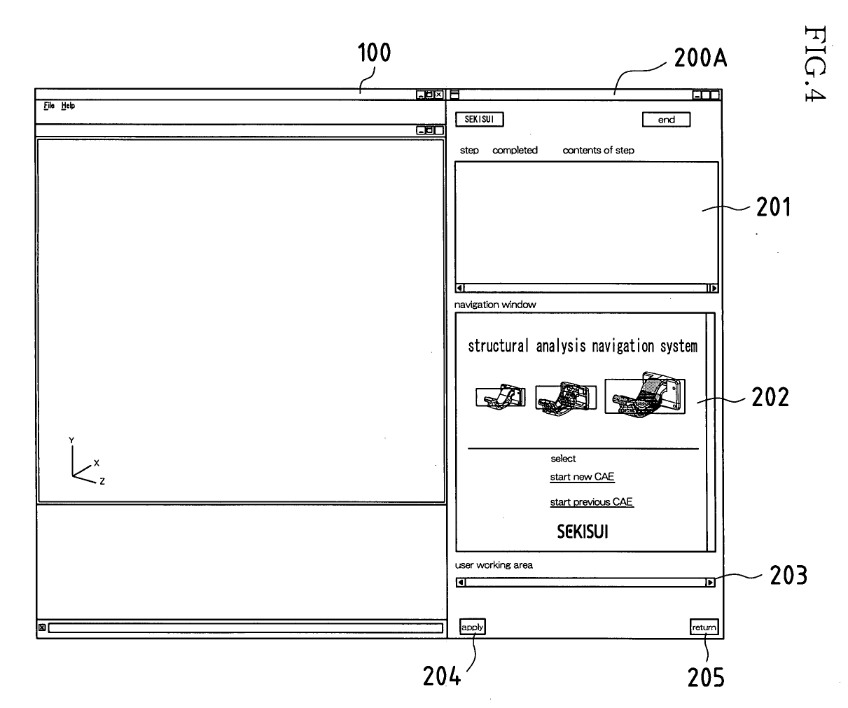

Initially, the operator boots the apparatus, which in turn displays an initial screen 200A (FIG. 4) on the display section 1, and then selects either “start new CAE” or “resume previous CAE” in the navigation window 202. It is here assumed that “start new CAE” is selected. Note that, when “resume previous CAE” is selected, an existing modeling database which has already been analyzed is opened.

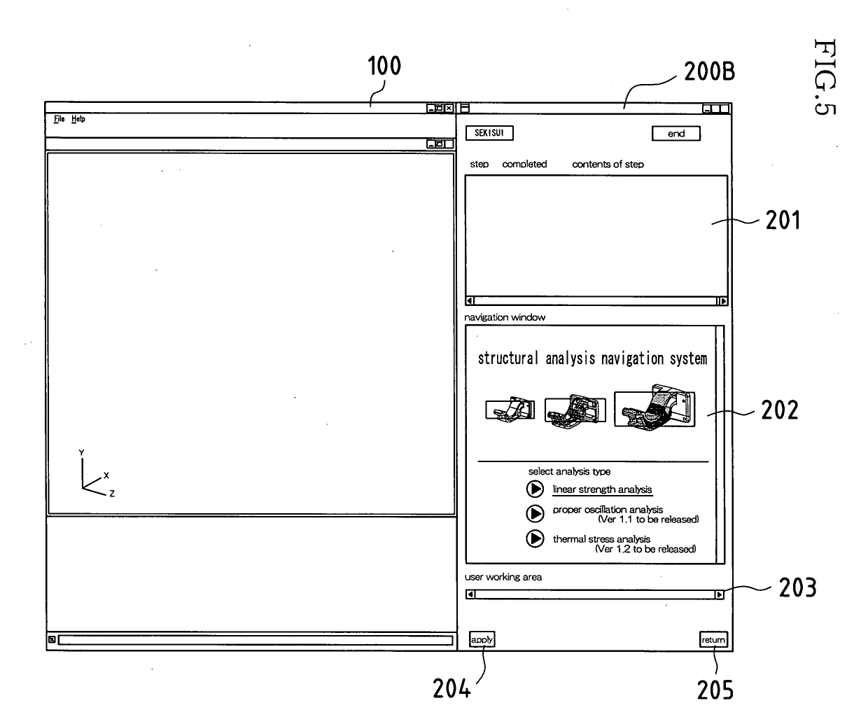

When “start new CAE” is selected, the interactive control section 8 activates the screen display program stored in the screen display program storing section 3 to display an analysis type selection screen 200B (FIG. 5) on the display section 1. The operator selects a type of analysis to be performed from contents displayed in the navigation window 202 on the analysis type selection screen 200B. Specifically, any of analysis types can be selected by shifting a cursor to an icon portion of a corresponding item displayed on the navigation window 202 and clicking the icon portion. It is here assumed that “linear strength analysis” is selected.

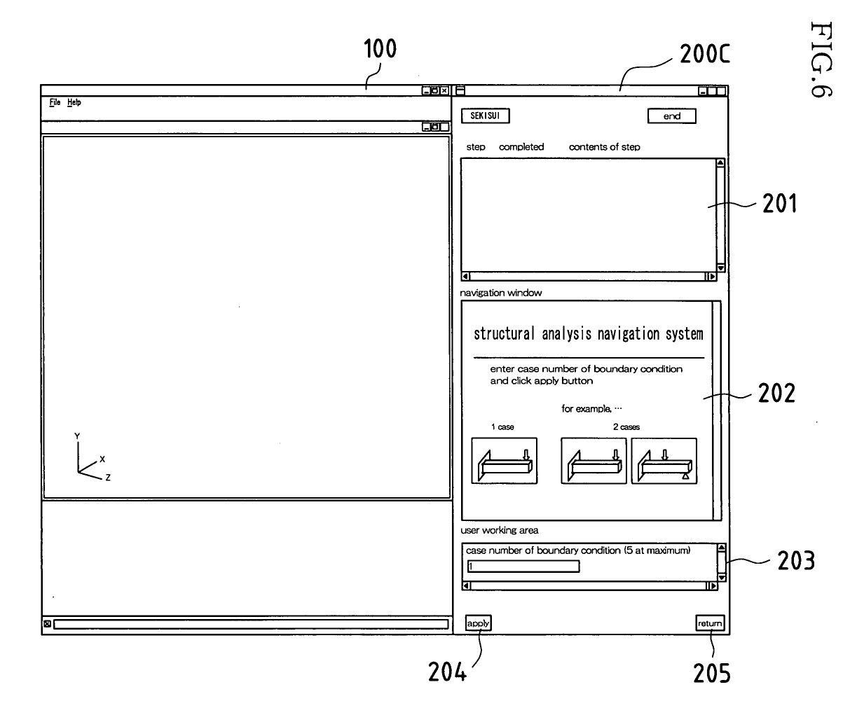

Thereby, a case number entry screen 200C (FIG. 6) is displayed on the display section 1.

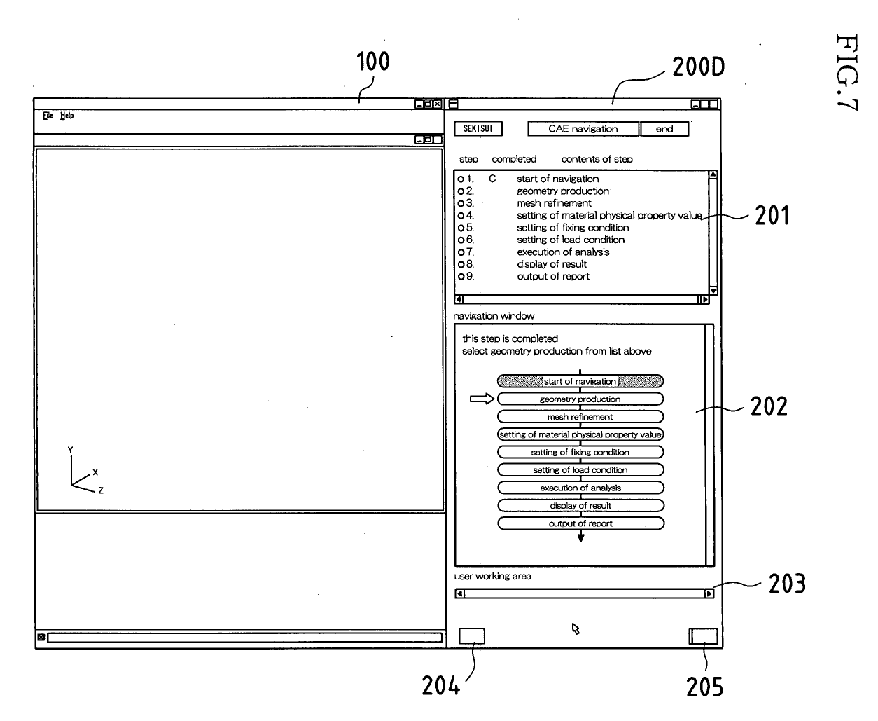

Next, the operator enters the case number of a boundary condition into the selection entry window 203 of the case number entry screen 200C, and thereafter, clicks an apply button 204 using a mouse or the like to determine the case number of the boundary condition. As a result, the display section 1 displays an analysis procedure display screen 200D (FIG. 7). Note that FIG. 7 illustrates an analysis procedure of structural analysis.

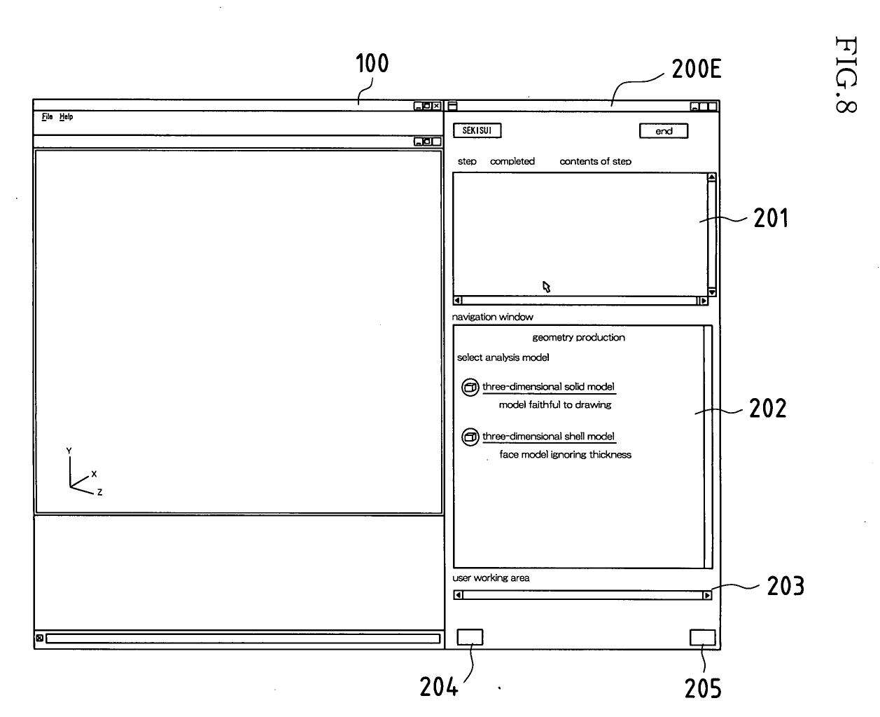

The navigation window 202 displayed at this time of the analysis procedure display screen 200D displays contents which instruct to select a geometry producing step among the steps of the analysis procedure. Specifically, a step in the navigation which has been ended is indicated with an inverted color, and an arrow is provided on a side of the geometry producing step. When the operator clicks the geometry production in the step display window 201 using a mouse or the like in accordance with the instruction, an analysis model selection screen 200E (FIG. 8) is displayed on the display section 1.

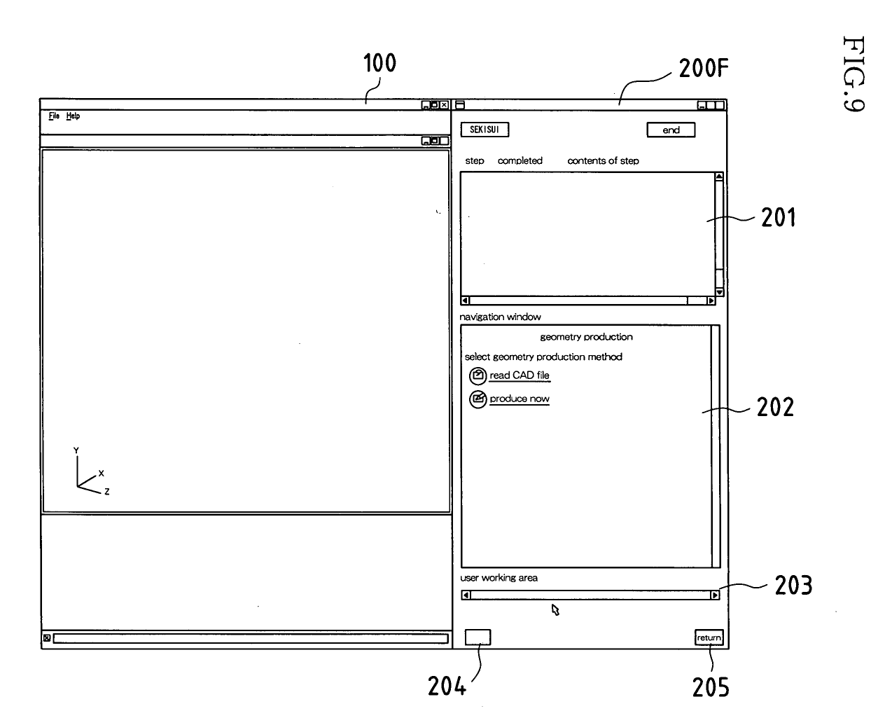

Next, the operator selects one of two types of analysis models displayed on the navigation window 202 of the analysis model selection screen 200E. Specifically, an analysis model is selected by shifting a cursor to an icon portion displayed on a left-hand side of a corresponding item and clicking the icon portion. When it is here assumed that “three-dimensional shell model” is selected, a geometry production screen 200F (FIG. 9) is displayed on the display section 1.

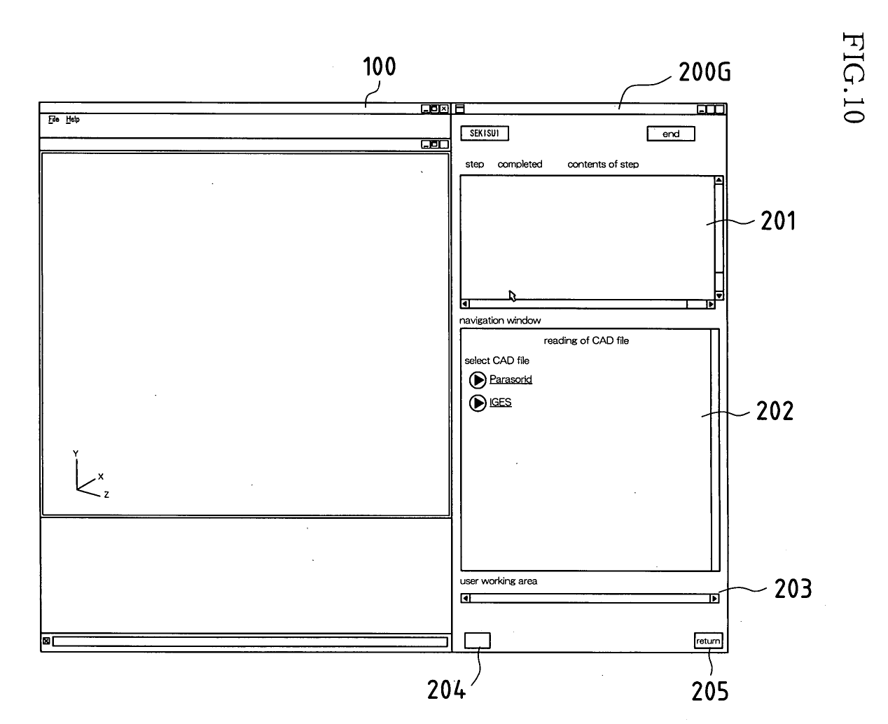

Next, the operator selects one of two types of geometry producing methods which are displayed in the navigation window 202 of the geometry production screen 200F. Specifically, a geometry producing method is selected by shifting a cursor to an icon portion displayed on a left-hand side of a corresponding item and clicking the icon portion. When it is here assumed that “read CAD file”, a CAD file selection screen 200G (FIG. 10) is displayed on the display section 1.

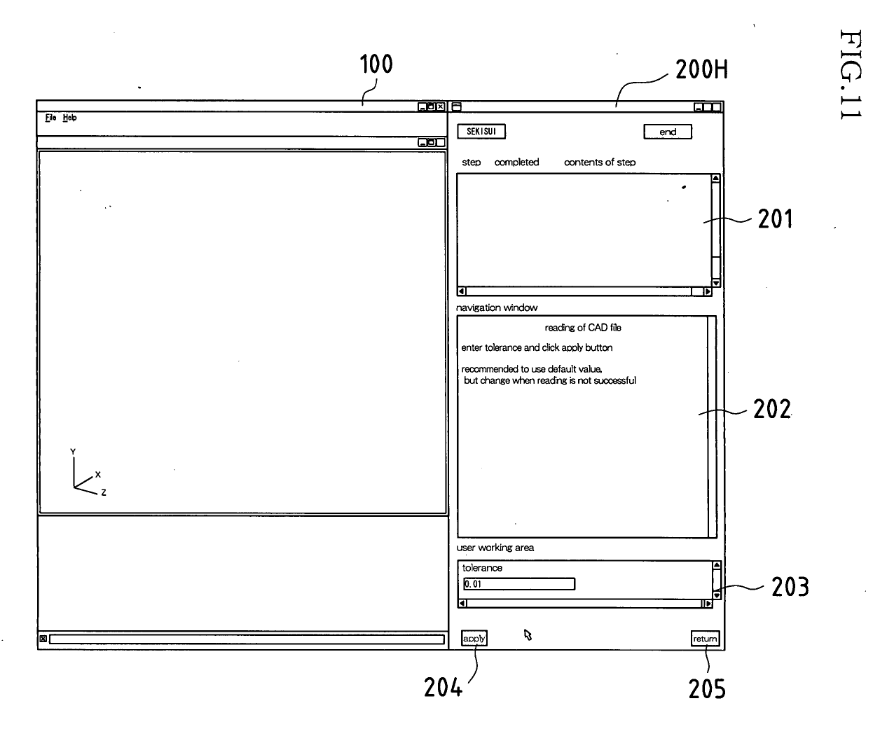

Next, the operator selects one of two types of CAD files which are displayed on the navigation window 202 of the CAD file selection screen 200G. Specifically, a geometry producing method is selected by shifting a cursor to an icon portion displayed on a left-hand side of a corresponding item and clicking the icon portion. When it is here assumed that “IGES” is selected, a CAD file selection screen 200H (FIG. 11) is displayed on the display section 1.

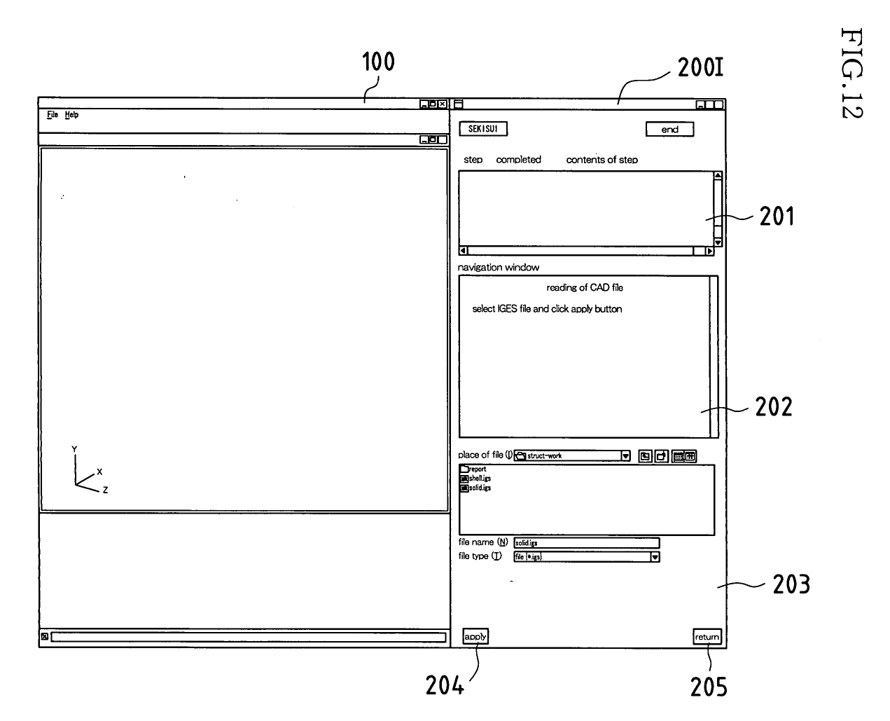

Next, the operator enters an tolerance into the entry window 203 in accordance with an instruction displayed on the navigation window 202 of the CAD file selection screen 200H, and then clicks the apply button 204 using a mouse or the like, so that a CAD file selection screen 200I (FIG. 12) is displayed on the display section 1.

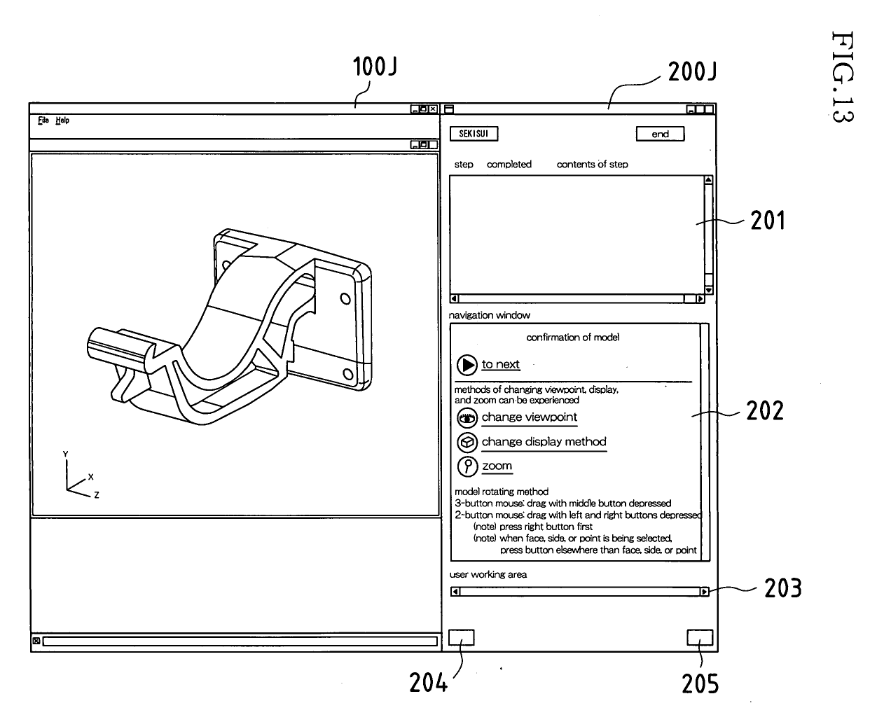

Next, the operator selects one of files displayed in an upper portion of the entry window 203 in accordance with an instruction displayed in the navigation window 202 of the CAD file selection screen 200I, and then clicks the apply button 204 using a mouse or the like, so that a model screen 100J and a model confirmation screen 200J for confirming a model geometry (FIG. 13) is displayed on the display section 1.

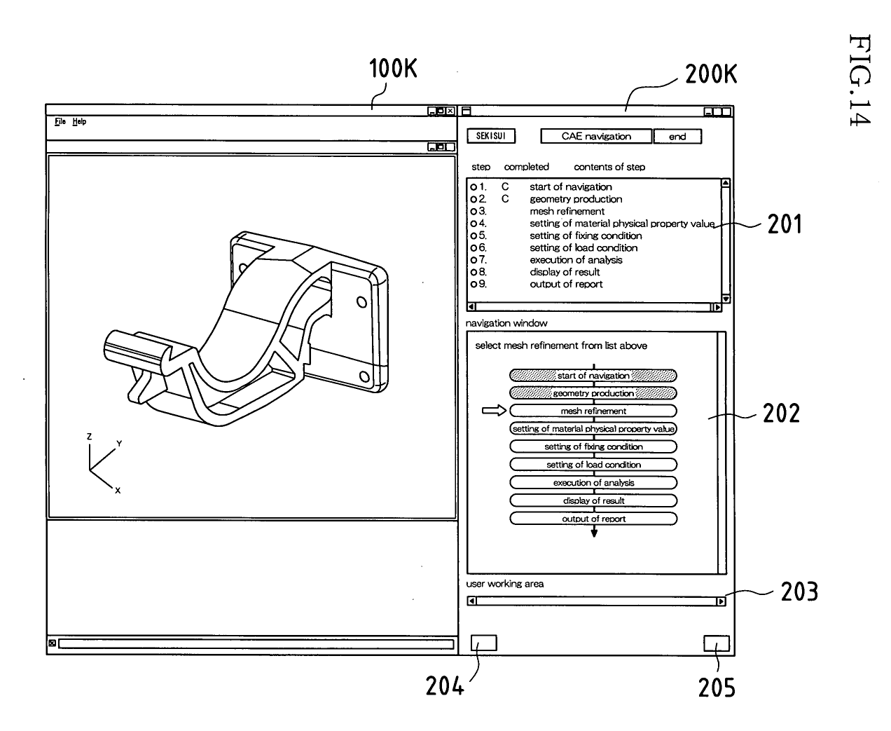

Next, the operator visually confirms an analysis model (three-dimensional shell model) displayed on the model screen 100J while changing viewpoints, changing display methods, or zooming as required. Thereafter, the operator clicks an icon describing “to next” displayed on the navigation window 202, so that a model screen 100K and an analysis procedure display screen 200K (FIG. 14) is displayed on the display section 1.

The analysis procedure display screen 200K is the same as the analysis procedure display screen 200D of FIG. 7. However, in this case, the displayed contents of the navigation window 202 for displaying the steps of the analysis procedure indicate the next instruction to select mesh refinement.

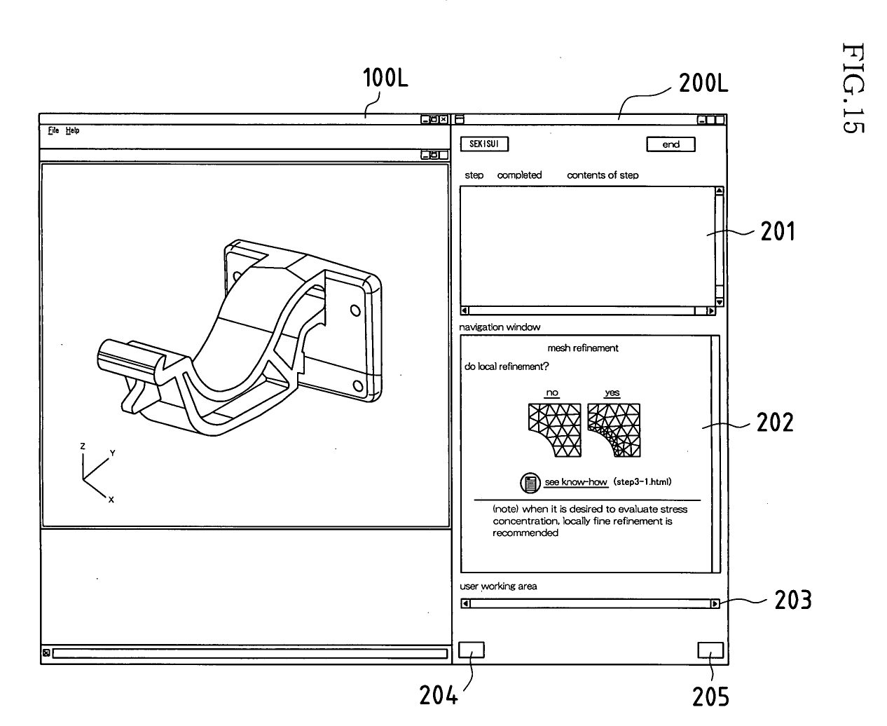

FIG. 15 illustrates a model screen 100L and a mesh refinement confirmation screen 200L. The mesh refinement confirmation screen 200L includes the step display window 201 indicating to what stage entry has proceeded, the navigation window 202 in which the presence or absence of local refinement is confirmed in an interactive manner, and the entry window 203 which is a user working area.

The details of the subsequent portion of the analysis procedure will not be explained. Briefly, the operator performs the following steps in accordance with navigation instructions successively displayed on the menu screen 200: mesh refinement, material selection (determination of physical property values of material), setting of conditions corresponding to analysis contents (e.g., setting of a fixing condition and setting of a load condition in structural analysis; setting of a forming condition in flow analysis; setting of a boundary condition in heat analysis; etc.), and execution of analysis. These portions of the analysis procedure are disclosed in, for example, Patent Publication 2 and JP 2003-296371 A which have already been filed by the present applicant.

The basic operation of the CAE analysis navigation system of the present invention has been heretofore described. Although, in the foregoing description, the model screen 100 and the menu screen 200 are displayed side by side on the display screen of the display section 1, the present invention has a certain degree of freedom with respect to such a display form. The analysis process can be shared and performed by a plurality of the terminal apparatuses 10. Hereinafter, a specific description will be given.

### Description of Exemplary Processing Operation of CAE Analysis of the Embodiment

This example is characterized in that the above-described basic operation of CAE analysis is shared and performed by the terminal apparatuses 10A, 10B, and 10C of FIG. 1.

The CAE analysis processing program of the present invention is previously installed and the same model file is previously stored in each of the terminal apparatuses 10A, 10B, and 10C.

A situation is assumed for each terminal apparatus as follows: (a) the operator of the terminal apparatus 10A is the first to start an analysis task; (b) the operator of the terminal apparatus 10A is good at setting of conditions; (c) the operator of the terminal apparatus 10B is good at mesh refinement; and (d) the terminal apparatus 10C performs only a preprocess of CAE, but not analysis.

The procedure of CAE analysis of the present invention will be described in accordance with the above-described conditions.

(1) Start of Analysis Task

The operator of the terminal apparatus 10A boots the system, determines an analysis task name, and connects to the communication network N. Specifically, the operator registers the terminal apparatus 10A into a designated analysis task on the network.

On the other hand, the operators of the terminal apparatuses 10B and 10C take part in the analysis task designated by the operator of the terminal apparatus 10A. Specifically, the operators register the respective terminal apparatuses 10B and 10C into the designated analysis task on the network.

(2) Reading of Analysis Model

The operator of the terminal apparatus 10A reads an analysis model. In this case, the terminal apparatus 10A transmits model read information to the other terminal apparatuses 10B and 10C registered in the designated analysis task.

The terminal apparatuses 10B and 10C, which have received the model read information, read the same model as that which has been read by the terminal apparatus 10A.

(3) Edition of Analysis Condition

Next, the operator of the terminal apparatus 10A edits an analysis condition (e.g., a fixing condition and a load condition in structural analysis; a forming condition in flow analysis; a boundary condition in heat analysis; etc.), depending on the analysis contents. The terminal apparatus 10A transmits the analysis condition information thus set to the other terminal apparatuses 10B and 10C.

The other terminal apparatuses 10B and 10C, which have received the analysis condition information, edit the analysis condition set by the terminal apparatus 10A. Thereby, the condition set in the terminal apparatus 10A is also reflected on the terminal apparatuses 10B and 10C.

(4) Confirmation of Condition

The operator of each of the terminal apparatuses 10A, 10B, and 10C exchanges a message with the operators of the other terminal apparatuses to confirm the set analysis condition. Here, the message is transmitted and received between each terminal using a chat function.

(5) Start of Mesh Refinement

Mesh refinement is performed by the operator of the terminal apparatus 10B. Specifically, the operator of the terminal apparatus 10B informs the other terminal apparatuses 10A and 10C of start of mesh refinement.

After receiving the start information from the terminal apparatus 10B, the operators of the other terminal apparatuses 10A and 10C return acknowledgment information in response to the start information. Note that, when the operators of the other terminal apparatuses 10A and 10C do not perform mesh refinement, the operators of the other terminal apparatuses 10A and 10C inform the terminal apparatus 10B that mesh refinement is not performed, and withdraw from the joint task.

After receiving the acknowledgment information from the other terminal apparatuses 10A and 10C, the operator of the terminal apparatus 10B starts mesh refinement.

Also, the operators of the other terminal apparatuses 10A and 10C start mesh refinement in accordance with the condition set by the operator of the terminal apparatus 10B.

The operations of the terminal apparatuses 10A, 10B, and 10C are limited until the terminal apparatuses 10A, 10B, and 10C end the mesh refinement.

(6) End of Mesh Refinement

After ending the mesh refinement, each of the terminal apparatuses 10A, 10B, and 10C informs the other terminal apparatuses that it has ended the mesh refinement.

(7) Start of Analysis

After confirming the mesh refinement in each of the terminal apparatuses 10A, 10B, and 10C, the operator of the terminal apparatus 10B performs an analysis task. Specifically, the operator of the terminal apparatus 10B informs the other terminal apparatuses 10A and 10C of start of the analysis task.

After receiving the start information from the terminal apparatus 10B, the operators of the other terminal apparatuses 10A and 10C return acknowledgement information in response to the start information. Note that, when the operators of the other terminal apparatuses 10A and 10C do not perform the analysis task, the operators of the other terminal apparatuses 10A and 10C inform the terminal apparatus 10B that the analysis task is not performed, and withdraw from the joint task at this time. In this embodiment, the operator of the terminal apparatus 10C withdraws from the joint task at this time without performing the analysis task.

When receiving the acknowledgement information from the other terminal apparatuses 10A and 10C, the operator of the terminal apparatus 10B starts the analysis task. The operator of the other terminal apparatus 10A also starts the analysis task in accordance with the analysis condition set by the operator of the terminal apparatus 10B.

The operations of the terminal apparatuses 10A and 10B are limited until the terminal apparatuses 10A and 10B end the analysis task.

(8) End of Analysis

After ending the analysis task, each of the terminal apparatuses 10A and 10B informs the other apparatus that it has ended the analysis task.

(9) End of Analysis Task

After receiving the analysis task ending information, each of the operators of the terminal apparatuses 10A and 10B exchanges a message with the operator of the other terminal apparatus to confirm a result of the analysis, and thereafter, ends the allotted tasks, and withdraws from the joint task. Note that it is only the joint task on the network that is ended, and subsequent report production and the like are performed by the terminal apparatuses separately.

An exemplary processing operation of CAE analysis of the embodiment of the present invention has been heretofore described.

### Description of Examples of Support, Education, or the like of Analysis Task Using Network

Next, examples of support, education, or the like of an analysis task using a network will be described in the cases of structural analysis, flow analysis, and heat analysis separately.

### Example 1

Example 1 is an example in the case of structural analysis.

The CAE analysis processing program (here, a structural analysis processing program) of the present invention is previously installed and the same model file of an analysis object is previously stored in each of the terminal apparatuses 10A and 10B.

A situation is assumed for each terminal apparatus as follows: (a) the operator of the terminal apparatus 10A is the first to start the analysis task; (b) the operator of the terminal apparatus 10A is a beginner of CAE analysis, and the operator of the terminal apparatus 10B is a skilled operator of CAE analysis; and (c) the skilled operator supervises and supports the beginner.

Examples of support, education, and the like of the analysis task according to the present invention will be hereinafter described along a flow of the analysis procedure performed in accordance with the above-described conditions.

(1) Start of Analysis Task

The operator of the terminal apparatus 10A boots the system, determines an analysis task name, and connects to the communication network N. Specifically, the operator registers the terminal apparatus 10A into a designated analysis task on the network.

On the other hand, the operator of the terminal apparatus 10B takes part in the analysis task designated by the terminal apparatus 10A. Specifically, the operators register the terminal apparatus 10B into the designated analysis task on the network.

(2) Reading of Analysis Model

The operator of the terminal apparatus 10A reads an analysis model. In this case, the terminal apparatus 10A transmits model read information to the other terminal apparatus 10B registered in the designated analysis task.

The terminal apparatus 10B, which has received the model read information, reads the same model as that which has been read by the terminal apparatus 10A.

(3) Edition and Confirmation of Analysis Condition

Next, the operator of the terminal apparatus 10A edits an analysis condition, such as a fixing condition, a load condition, or the like.

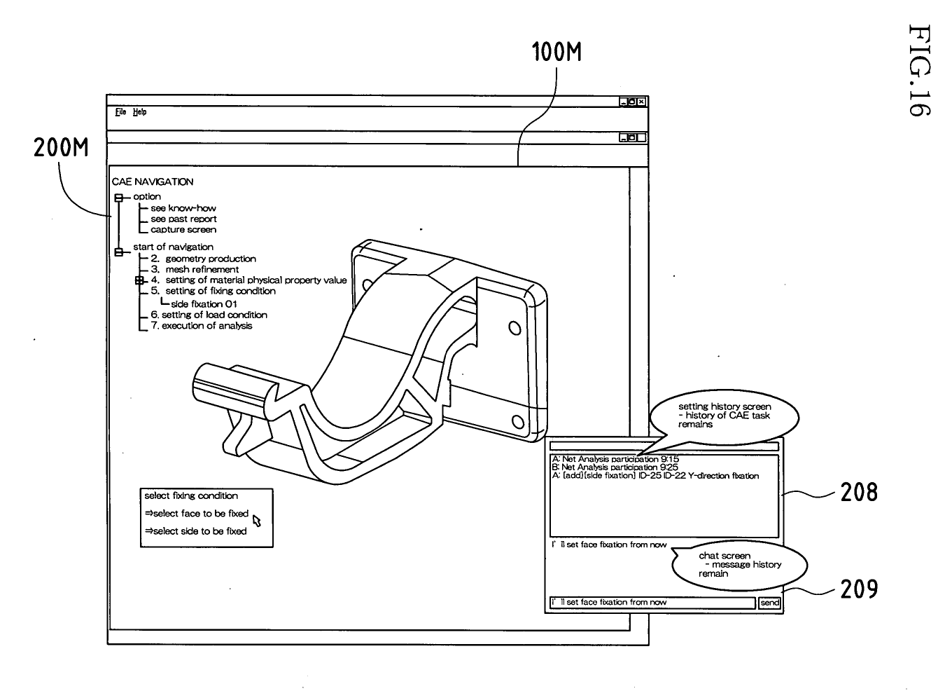

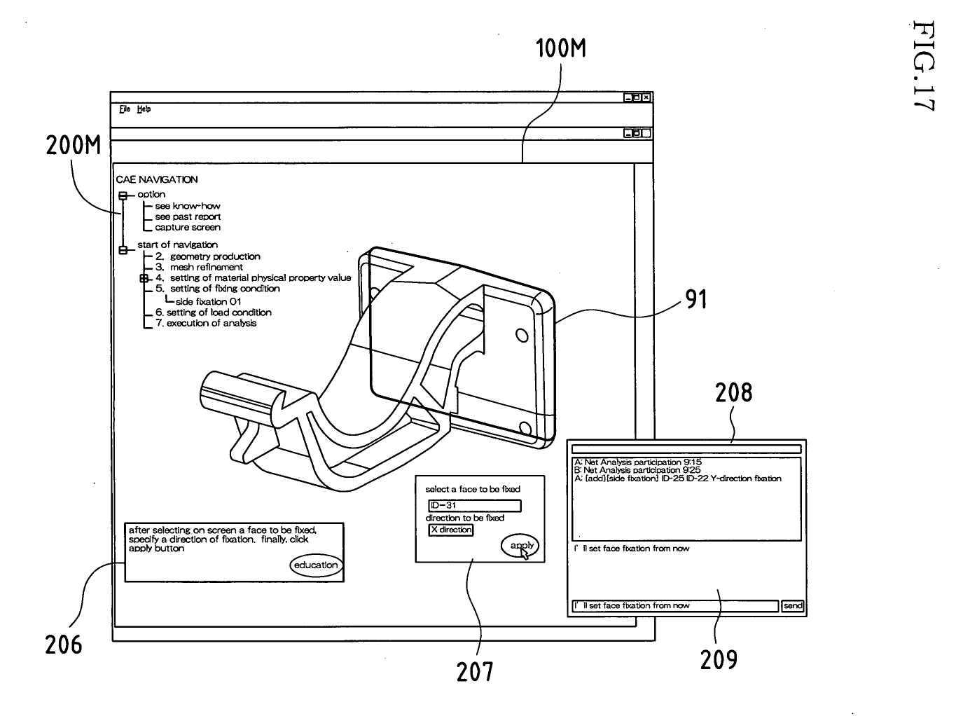

FIGS. 16 and 17 illustrate exemplary screens for setting a fixing condition of the terminal apparatus 10A. The setting screen shows a menu screen 200M as a transparent tree structure on a screen of a model screen 100M, and this display form will be described below and elsewhere herein. Specifically, FIG. 16 illustrates a situation where the operator of the terminal apparatus 10A has selected the setting of a fixing condition through the tree structure transparent menu screen 200M, and has selected face fixation. A setting history screen 208 and a chat screen 209 are displayed on the model screen 100M. A setting history of the CAE task remains on the setting history screen 208, and a history of messages transmitted and received between the terminal apparatuses remains on the chat screen 209. FIG. 17 illustrates a screen for setting face fixation in accordance with an instruction on a transparent description screen 206 displayed immediately below the menu screen 200M. Reference numeral 91 in FIG. 17 indicates a selected fixed face. Conditions are set through an entry box 207 shown in a lower right portion of FIG. 17, and the settings are confirmed by pushing down an apply button. After the apply button is pushed down, information about the face fixation 01 is transmitted to the other terminal apparatus 10B. As a result, the condition set in the terminal apparatus 10A is also reflected in the terminal apparatus 10B.

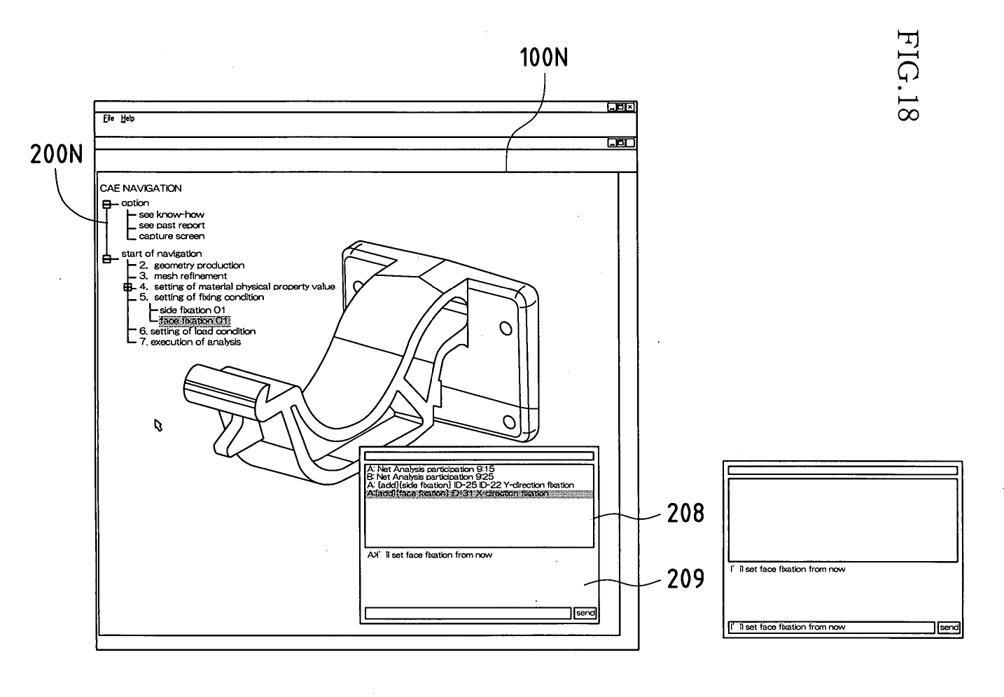

FIG. 18 illustrates an exemplary display screen of the terminal apparatus 10B, which receives the information about the face fixation 01. The face fixation 01 added by the terminal apparatus 10A is additionally displayed on a tree structure menu screen 200N, and face fixation information (hatched in FIG. 18) is added in the setting history screen 208 displayed in a lower right position of the screen.

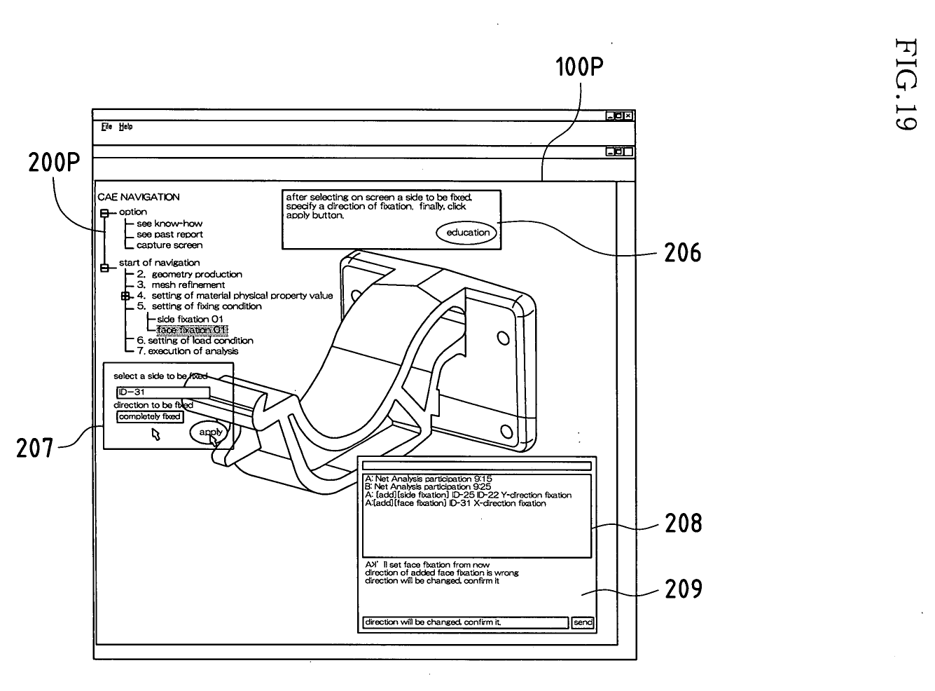

In the terminal apparatus 10B, a condition of the face fixation 01 set by the terminal apparatus 10A is selected, and contents of the condition are edited. FIG. 19 illustrates an exemplary screen in a situation where contents are edited in the terminal apparatus 10B. In this case, a fixing direction set by the terminal apparatus 10A has an error, and therefore, the operator of the terminal apparatus 10B is to correct the fixing direction. Specifically, the chat screen 209 is utilized to inform the terminal apparatus 10A that the operator of the terminal apparatus 10B is trying to change the face fixation 01. The set condition is corrected in the transparent entry box 207 displayed immediately below the menu screen 200N, and the corrected setting is confirmed by pushing down an apply button. After the apply button is pushed down, the corrected information about the face fixation 01 is transmitted to the terminal apparatus 10A. Thereby, the condition of the face fixation 01 corrected in the terminal apparatus 1B is reflected in the terminal apparatus 10A.

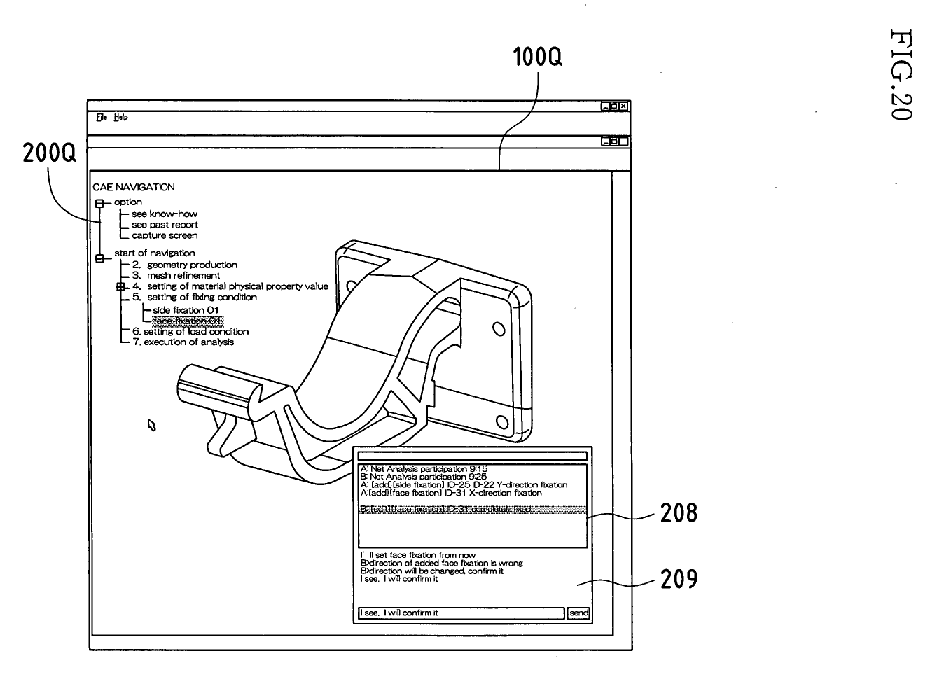

FIG. 20 illustrates an exemplary display screen of the terminal apparatus 10A, which has received the corrected information about the face fixation 01. The face fixation 01 of the tree of a menu screen 200Q corrected and changed by the terminal apparatus 10B is highlighted (hatched in FIG. 20), indicating such a change. A setting history (hatched in FIG. 20) is added in the setting history screen 208 in a lower right portion of the screen.

As described above, each of the operators of the terminal apparatuses 10A and 10B exchanges a message with the operator of the other terminal apparatus via a chat screen, and confirms a set analysis condition. In other words, the operator of the terminal apparatus 10B confirms the history of condition settings, points out a problem, and provides a support. In this example, it is possible to confirm an operation history for each terminal apparatus from the condition setting history.

(4) Start of Mesh Refinement

The operator of the terminal apparatus 10A performs mesh refinement. Specifically, the operator of the terminal apparatus 10A informs the other terminal apparatus 10B of start of mesh refinement.

After receiving the start information from the terminal apparatus 10A, the operator of the terminal apparatus 10B confirms a current analysis condition or the like before returning start acknowledgement information. Specifically, the operator of the terminal apparatus 10B confirms whether or not the mesh refinement setting set by the terminal apparatus 10A is appropriate.

After receiving acknowledgement information from the terminal apparatus 10B, the operator of the terminal apparatus 10A starts mesh refinement.

The operator of the terminal apparatus 10B also starts mesh refinement in accordance with the condition set by the operator of the terminal apparatus 10A.

The operations of the terminal apparatuses 10A and 10B are limited until the terminal apparatuses 10A and 10B end the mesh refinement.

(5) End of Mesh Refinement

After ending the mesh refinement, each of the terminal apparatuses 10A and 10B informs the other terminal apparatus that it has ended the mesh refinement.

(6) Start of Analysis

After the mesh refinement is confirmed in each of the terminal apparatuses 10A and 10B, the operator of the terminal apparatus 10A performs an analysis task. Specifically, the operator of the terminal apparatus 10A informs the other terminal apparatus 10B of start of the analysis task.

After receiving the start information from the terminal apparatus 10A, the operator of the terminal apparatus 10B finally confirms the analysis task and returns acknowledgement information to the terminal apparatus 10A using the condition setting history and the chat function.

After receiving the acknowledgement information from the terminal apparatus 10B, the operator of the terminal apparatus 10A starts the analysis task. The operator of the terminal apparatus 10B also starts the analysis task in accordance with the analysis condition set by the operator of the terminal apparatus 10A.

The operations of the terminal apparatuses 10A and 10B are limited until the terminal apparatuses 10A and 10B end the analysis task.

(7) End of Analysis

After the analysis task is ended, each of the terminal apparatuses 10A and 10B informs the other terminal apparatus that it has ended the analysis task.

(8) Confirmation of Analysis Result

After receiving the end information about the analysis task, the operator of the terminal apparatus 10B reviews the analysis condition or the like based on the analysis result, and exchanges a message with the operator of the terminal apparatus 10A using the chat function to provide an advice, a support or the like to the operator of the terminal apparatus 10A. Thereafter, the terminal apparatus 10B is disconnected from the network.

Similarly, the operator of the terminal apparatus 10A disconnects from the network, and performs subsequent report production or the like.

### Example 2

Example 2 is an example in the case of flow analysis.

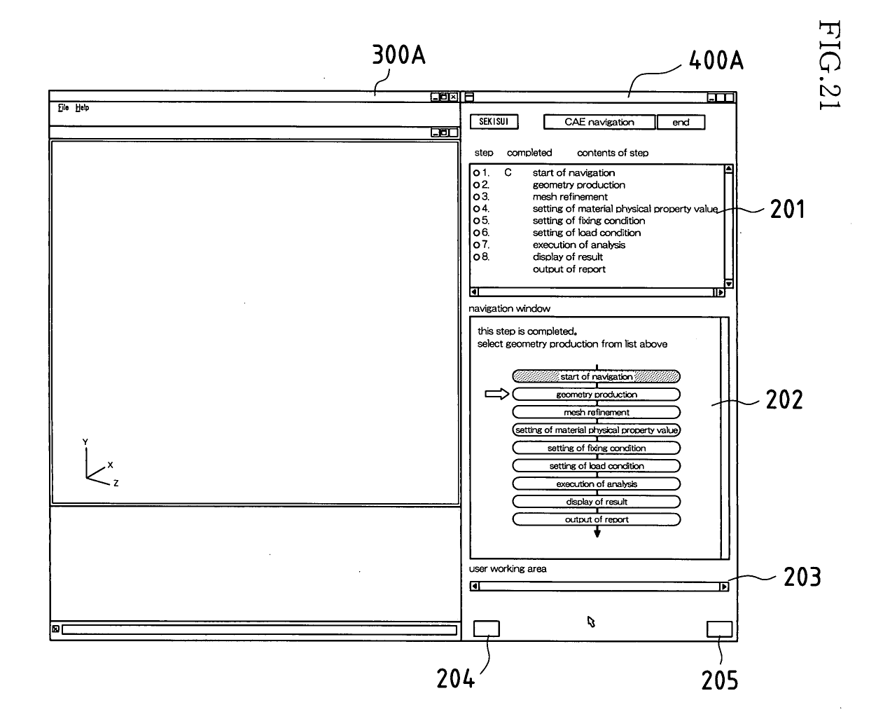

FIG. 21 illustrates an analysis procedure display screen 400A in the case of flow analysis. The analysis procedure display screen 400A is different from the analysis procedure display screen 200D in the case of structural analysis of FIG. 7 in the condition setting procedure. Specifically, whereas there are the “setting of a fixing condition” and the “setting of a load condition” in the case of structural analysis, there is “setting of a forming condition” in the case of flow analysis. Specifically, in the case of flow analysis, steps of (1) starting an analysis task, (2) reading an analysis model, (4) starting mesh refinement, (5) ending mesh refinement, (6) starting analysis, (7) ending analysis, (8) confirming an analysis result, and the like, are the same as those in the procedure described in the above-described section “Example of Structural Analysis”. The only difference is setting of a condition, i.e., (3) edition and confirmation of an analysis condition. Therefore, only (3) edition and confirmation of an analysis condition will be hereinafter described and the other steps will not be explained.

(3) Edition and Confirmation of Analysis Condition

The operator of the terminal apparatus 10A edits analysis conditions which are forming conditions, such as a resin/mold temperature, a filling time, and the like.

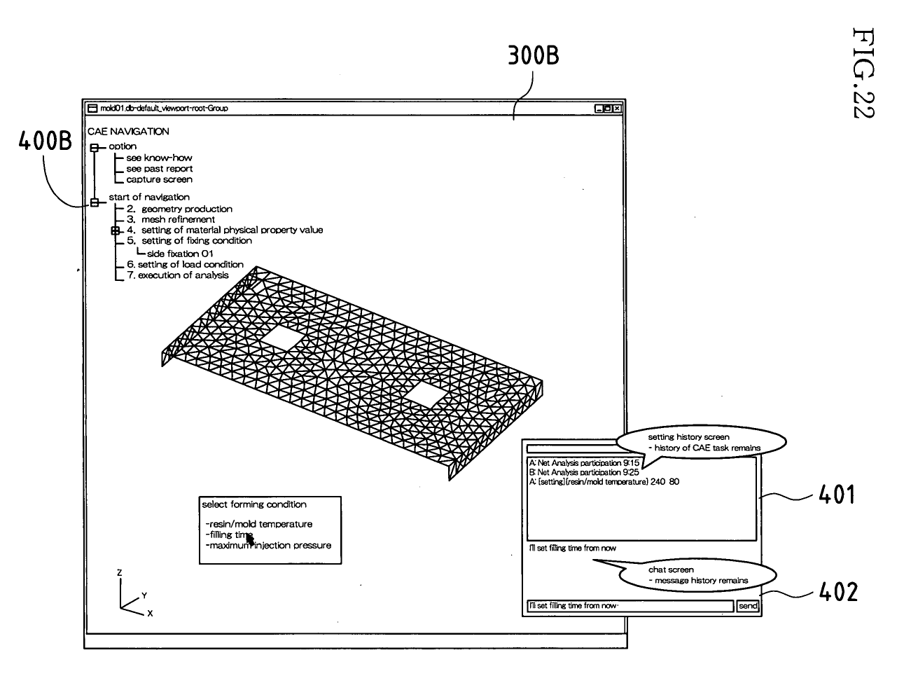

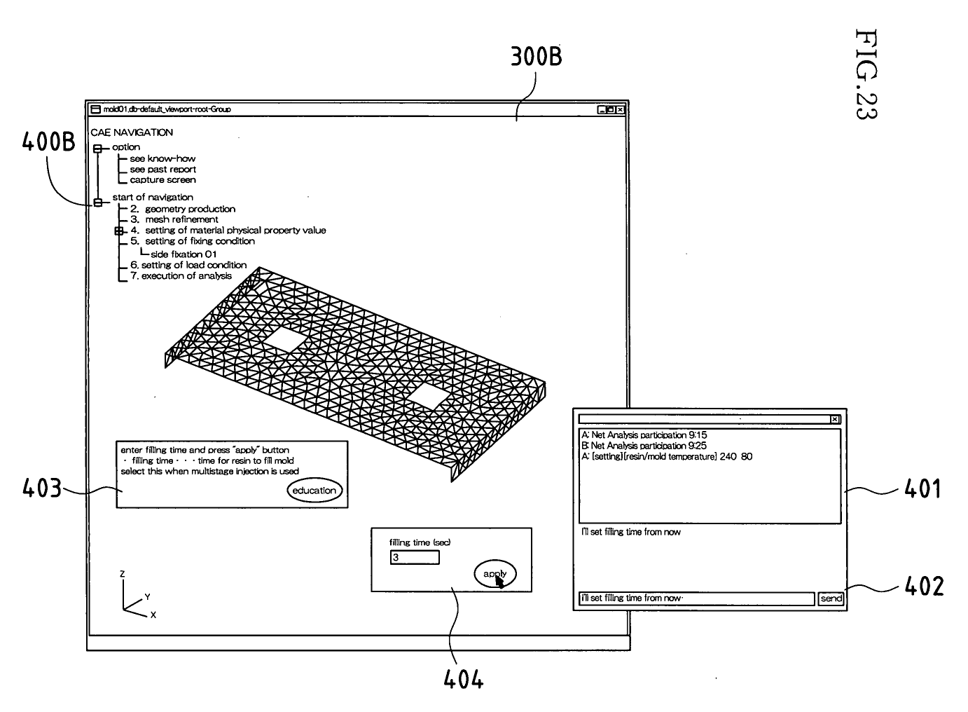

FIGS. 22 and 23 illustrate exemplary screens for setting forming conditions in the terminal apparatus 10A. In these setting screens, a menu screen 400B is displayed as a transparent tree structure on a screen of a model screen 300B, and this display situation will be described below and elsewhere herein. Specifically, FIG. 22 illustrates a situation where the operator of the terminal apparatus 10A selects setting of forming conditions from the tree structure transparent menu screen 400B, and selects a filling time from the forming conditions. On the model screen 300B, a setting history screen 401 and a chat screen 402 are displayed. A setting history of a CAE task remains on the setting history screen 401, and a history of messages transmitted and received between the terminal apparatuses remains on the chat screen 402. FIG. 23 illustrates a screen for setting a filling time in accordance with an instruction in a transparent description screen 403 displayed immediately below the menu screen 400B. A filling time is set in an entry box 404 displayed in a lower right portion of FIG. 23, and the setting is confirmed by pushing down an apply button. After the apply button is pushed down, the filling time information is transmitted to the other terminal apparatus 10B. Thereby, the condition set in the terminal apparatus 10A is also reflected in the terminal apparatus 10B.

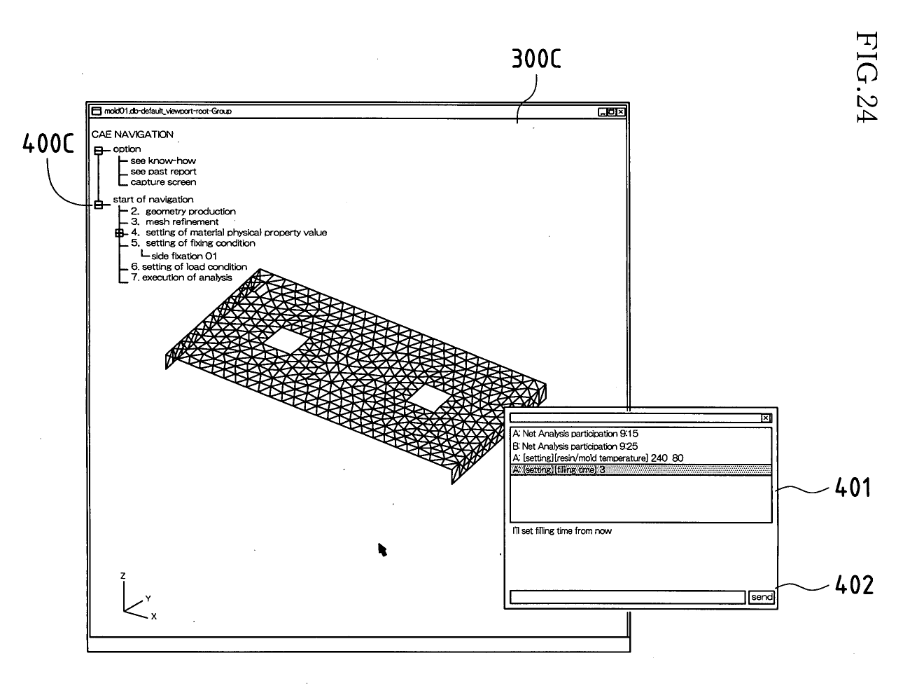

FIG. 24 illustrates an exemplary display screen of the terminal apparatus 10B, which has received the filling time information. The filling time (3 minutes) added by the terminal apparatus 10A is added as filling time information (hatched in FIG. 23) into the setting history screen 401 displayed in a lower right portion of the screen.

In the terminal apparatus 10B, the condition of the filling time (3 minutes) set by the terminal apparatus 10A is selected, and contents of the condition are edited.

Note that no exemplary screen in a situation where the contents are edited in the terminal apparatus 10B is illustrated. However, when the filling time set by the terminal apparatus 10A is not appropriate, the operator of the terminal apparatus 10B corrects the filling time on the edit screen. Specifically, the terminal apparatus 10B informs the terminal apparatus 10A that the operator of the terminal apparatus 10B is trying to change the filling time (3 minutes), using a chat screen (basically the same as the chat screen 209 of FIG. 20). Thereafter, the condition setting is corrected in a transparent entry box displayed immediately below the menu screen, and an apply button is pushed down, thereby determining the corrected setting. After the apply button is pushed down, the corrected filling time information is transmitted to the terminal apparatus 10A. Thereby, the filling time condition corrected and set by the terminal apparatus 1B is reflected in the terminal apparatus 10A.

As described above, each of the operators of the terminal apparatuses 10A and 10B exchanges a message with the operator of the other terminal apparatus using a chat screen, and confirms a set analysis condition. Specifically, the operator of the terminal apparatus 10B confirms a history of setting conditions, points out a problem, and provides a support. In this example, it is possible to confirm an operation history for each terminal apparatus from the condition setting history.

### Example 3

Example 3 is an example in the case of heat analysis.

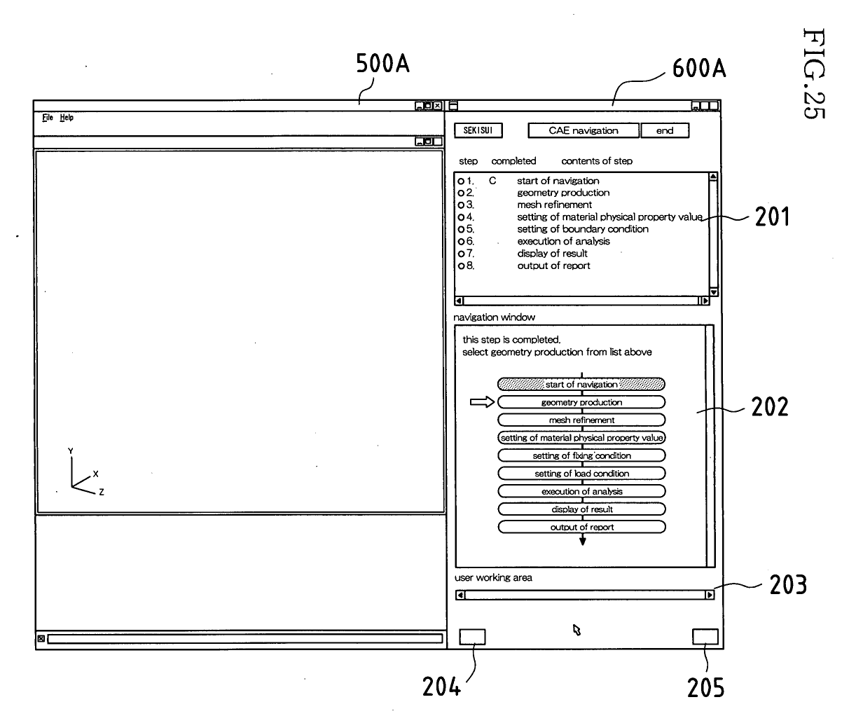

FIG. 25 illustrates an analysis procedure display screen 600A in the case of heat analysis. The analysis procedure display screen 600A is different from the analysis procedure display screen 200D in the case of structural analysis of FIG. 7 in the condition setting procedure. Specifically, whereas there are the “setting of a fixing condition” and the “setting of a load condition” in the case of structural analysis, there is “setting of a boundary condition” in the case of heat analysis. Specifically, in the case of heat analysis, steps of (1) starting an analysis task, (2) reading an analysis model, (4) starting mesh refinement, (5) ending mesh refinement, (6) starting analysis, (7) ending analysis, (8) confirming an analysis result, and the like, are the same as those in the procedure described in the above-described section “Example of Structural Analysis”. The only difference is setting of a condition, i.e., (3) edition and confirmation of an analysis condition. Therefore, only (3) edition and confirmation of an analysis condition will be hereinafter described and the other steps will not be explained.

(3) Edition and Confirmation of Analysis Condition

Next, the operator of the terminal apparatus 10A edits an analysis condition which is a boundary condition, such as a face temperature or the like.

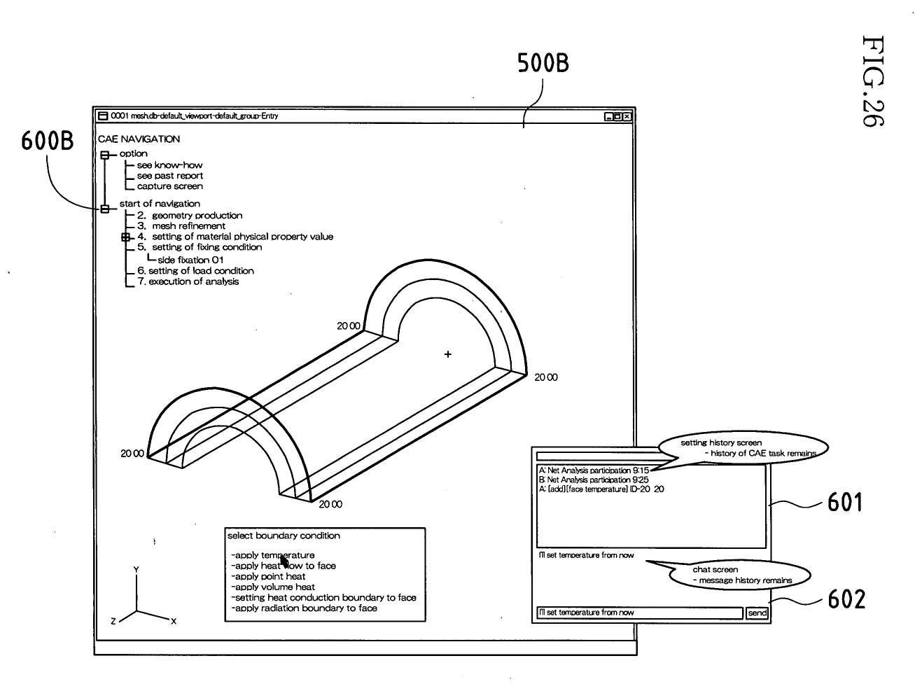

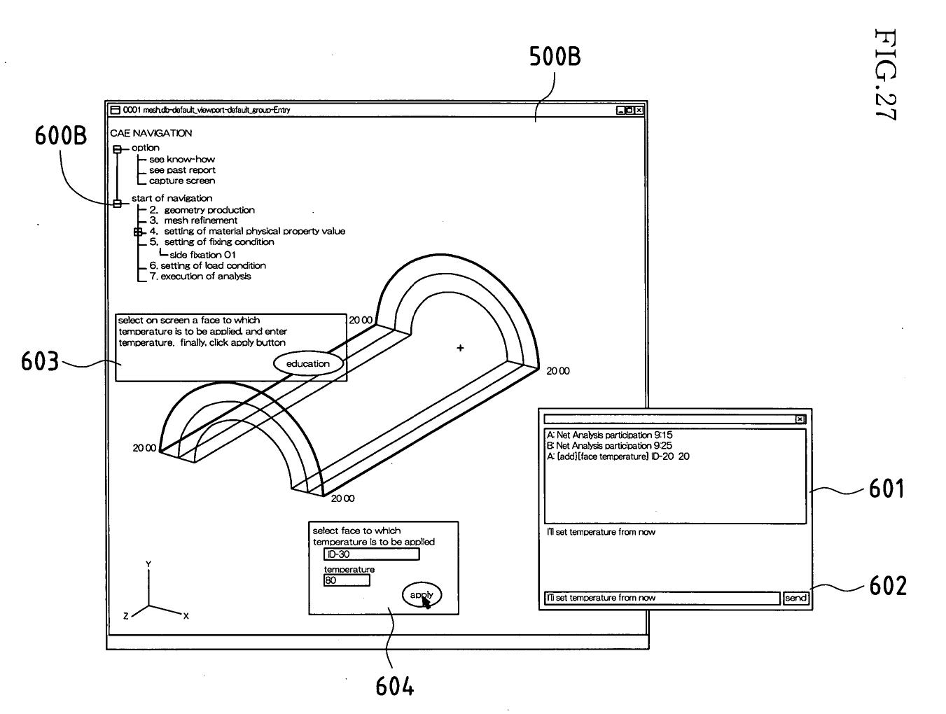

FIGS. 26 and 27 illustrate exemplary screens for setting a boundary condition in the terminal apparatus 10A. The setting screen shows a menu screen 600B as a transparent tree structure on a screen of a model screen 500B, and this display form will be described below and elsewhere herein. Specifically, FIG. 26 illustrates a situation where the operator of the terminal apparatus 10A has selected the setting of a boundary condition through the tree structure transparent menu screen 600B, and has selected temperature (“apply temperature to face”). A setting history screen 601 and a chat screen 602 are displayed on the model screen 500B. A setting history of a CAE task remains on the setting history screen 601, and a history of messages transmitted and received between the terminal apparatuses remains on the chat screen 602. FIG. 27 illustrates a screen for setting a face temperature in accordance with an instruction on a transparent description screen 603 displayed immediately below the menu screen 600B. A face to which a temperature is to be applied and the temperature are set through an entry box 604 shown in a lower right portion of FIG. 27, and the settings are confirmed by pushing down an apply button. After the apply button is pushed down, information about the filling time is transmitted to the other terminal apparatuses 10B. As a result, the condition set in the terminal apparatus 10A is also reflected in the terminal apparatus 10B.

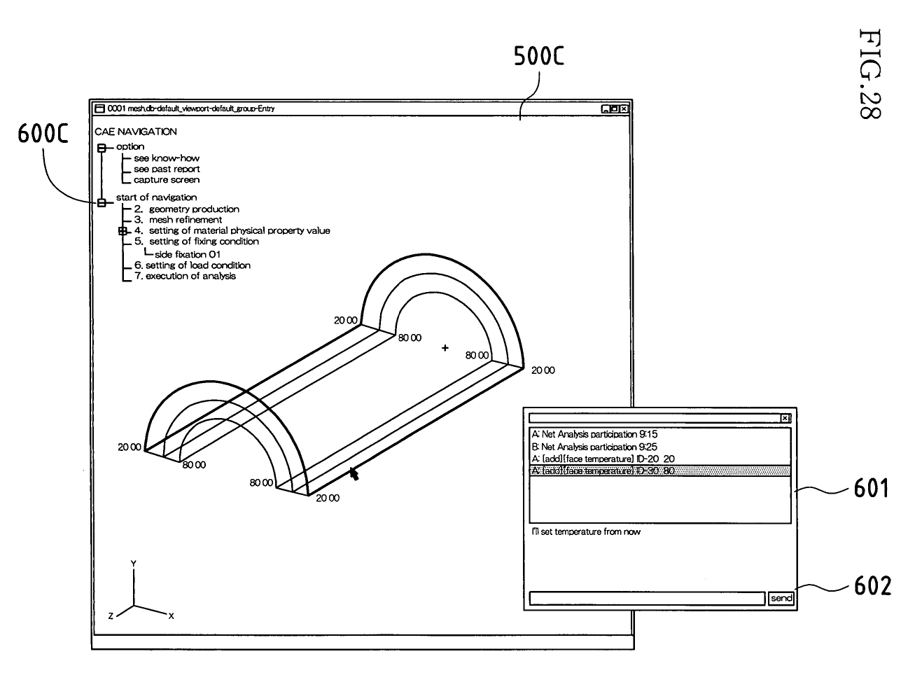

FIG. 28 illustrates an exemplary display screen of the terminal apparatus 10B which receives the information about the set face and face temperature. The face (ID-30) and face temperature (80 degrees) added by the terminal apparatus 10A are added as face and face temperature information (hatched in FIG. 28) on the setting history screen 601 displayed in a lower right position of the screen.

In the terminal apparatus 10B, conditions of the face and the face temperature (80 degrees) set by the terminal apparatus 10A are selected, and contents of the conditions are edited.

Note that no exemplary screen in a situation where the contents are edited in the terminal apparatus 10B is illustrated. However, when the face and the face temperature set by the terminal apparatus 10A are not appropriate, the operator of the terminal apparatus 10B corrects the face and the face temperature on the edit screen. Specifically, the terminal apparatus 10B informs the terminal apparatus 10A that the operator of the terminal apparatus 10B is trying to change both or either of the face and the face temperature, using a chat screen (basically the same as the chat screen 209 of FIG. 20). Thereafter, the condition setting is corrected in a transparent entry box displayed immediately below the menu screen, and an apply button is pushed down, thereby determining the corrected setting. After the apply button is pushed down, the corrected face and face temperature information is transmitted to the terminal apparatus 10A. Thereby, the face and face temperature conditions corrected and set by the terminal apparatus 1B are reflected in the terminal apparatus 10A.

As described above, each of the operators of the terminal apparatuses 10A and 10B exchanges a message with the operator of the other terminal apparatus using a chat screen, and confirms a set analysis condition. Specifically, the operator of the terminal apparatus 10B confirms a history of setting conditions, points out a problem, and provides a support. In this example, it is possible to confirm an operation history for each terminal apparatus from the condition setting history.

Examples 1 to 3 have been heretofore described in terms of support, education, and the like of an analysis task according to the present invention. Although not described, support, education, and the like of an analysis task can be similarly achieved with respect to other CAE analysis processes in addition to those described above.

Next, an example in which a degree of freedom is introduced to a procedure for an analysis task and a display form of the display screen of the display section 1, will be described.

### Description of Example in which Degree of Freedom Is Introduced to Analysis Task Procedure

In the foregoing description of the basic operation, for example, the analysis procedure of FIG. 7, i.e., the order of geometry production, mesh refinement, material selection, setting of a fixing condition, setting of a load condition, and an analysis task, is fixed. For example, when the task of setting a load condition is performed, and thereafter, the procedure returns to the fixing condition setting task or the material selection task, the steps of the returned task and thereafter need to be performed in the above-described order again. The tasks which have been previously performed are wasted. Therefore, this embodiment is devised so that a degree of freedom is introduced to an analysis task procedure.

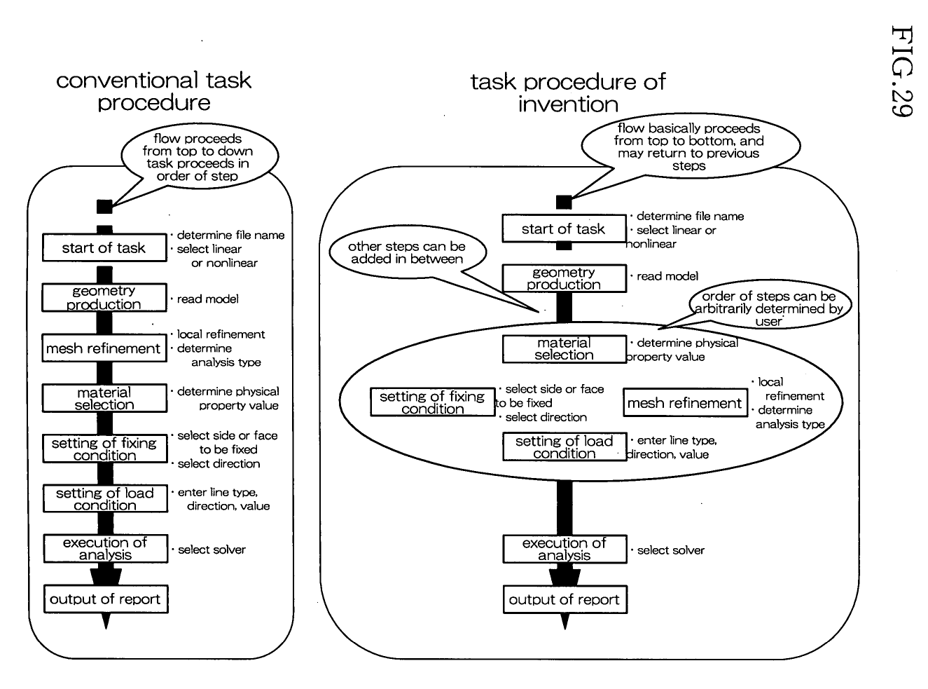

FIG. 29 is a diagram for conceptually explaining how a degree of freedom is introduced to an analysis task procedure. In FIG. 29, the left-hand portion illustrates a conventional task procedure, while the right-hand portion illustrates a task procedure of the present invention. Specifically, a system is constructed in which the order of tasks, i.e., mesh refinement, material selection, fixing condition setting, and load condition setting, can be freely determined by the operator. In this embodiment, steps of each task procedure are displayed in a tree-view as illustrated in FIGS. 16 to 20, FIGS. 22 to 24, and FIGS. 26 to 28. Thereby, a current task situation can be displayed to be easily recognized.

### Description of Example in which Degree of Freedom Is Introduced to Display Form

In the foregoing description of the basic operation, the menu screen 200 is consistently provided on the right-hand side of the model screen 100, and the arrangement and the positions are fixed. Therefore, when it may be desired to enlarge and display the model screen 100 to the entire screen of the display section 1 for operation in some procedures, the menu screen 200 may block such an enlarged display.

Therefore, in this embodiment, a display form of the model screen 100 and the menu screen 200 is devised to improve the operability of the model screen 100. Specifically, as has already been described with reference to FIGS. 16 to 20, in this embodiment, the menu screens 200M to 200Q including a tree structure are superposed as transparent windows (or semi-transparent windows) at arbitrary positions on the model screens 100M to 100Q enlarged and displayed on the entire screen of the display section 1 in manner which allows the model screens 100M to 100Q to perform display. In this case, various tasks can be performed with respect to a three-dimensional model enlarged and displayed on the model screens 100M to 100Q, while the three-dimensional model is not blocked by the menu screens 200M to 200Q. Further, as illustrated in FIGS. 16 to 20, screens, such as the menu screens 200M to 200G, the setting history screen 208, the chat screen 209, the description screen 206, and the entry box 207, are provided at arbitrary positions separately on the model screens 100M to 100Q in a manner which allows the model screens 100M to 100Q to perform display. Thereby, the operability for the operator is further improved. The same is true of the case of flow analysis illustrated in FIGS. 22 to 24 and the case of heat analysis illustrated in FIGS. 26 to 28.

The above-described CAE analysis navigation system is achieved by a CAE analysis processing program for successively performing an analysis procedure of CAE analysis applied in common to a common analysis object simultaneously and in association between terminal apparatuses. The present invention may be directed to the program itself or a computer readable recording medium storing the program.

In the present invention, as the recording medium, for example, ROM or the like itself may be a program medium. Alternatively, the recording medium may be a program medium which can be inserted into and read by a program reading apparatus (external storage apparatus not shown).

The program medium is herein a recording medium which is separably provided in the main body. Examples of the program medium include magnetic disks (e.g., FD (flexible disk), HD (hard disk), etc.), optical discs (e.g., CD-ROM, MO, MD, DVD, etc.), cards (e.g., IC card, optical card, etc.), semiconductor memories (masked ROM, EPROM, EEPROM, flash ROM, etc.), and the like.

The present invention has a system structure which allows connection to a communication network including the Internet. Therefore, the present invention may be a recording medium which holds a program which is not fixed and is downloaded from the communication network.

### INDUSTRIAL APPLICABILITY

The present invention is applicable in the fields of computer simulation which can be used for strength analysis, flow analysis or the like of products, and computer simulation which aids design for improvement of product quality.

1. A CAE analysis navigation system in which a plurality of terminal apparatuses storing an analysis procedure of CAE analysis as a program are connected via a communication network, wherein
the plurality of terminal apparatuses perform the analysis procedure of the CAE analysis with respect to an analysis object in accordance with separate entries through the terminal apparatuses, simultaneously and in association with each other via the communication network, and have a support function to reciprocally support an analysis task.

2. The CAE analysis navigation system according to claim 1, wherein the support function includes at least one of audio information, character information, image information including a moving image.

3. The CAE analysis navigation system according to claim 1, wherein the terminal apparatus comprises display means for displaying an analysis procedure screen for an object, general-purpose analysis procedure program storing means for storing a general-purpose analysis procedure program which navigates the analysis procedure of the CAE analysis applied in common to various analysis objects, and analysis calculation means for executing analysis calculation with respect to a specific object based on the general-purpose analysis procedure program stored in the general-purpose analysis procedure program storing means.

4. The CAE analysis navigation system according to claim 3, wherein the general-purpose analysis procedure program storing means is provided on the communication network.

5. The CAE analysis navigation system according to claim 3, wherein the display means displays a model screen for displaying a model of an analysis object, and a menu screen, and a display size of the menu screen can be changed.

6. The CAE analysis navigation system according to claim 3, wherein the display means displays a model screen for displaying a model of an analysis object, and a menu screen, and the menu screen is superposed as a transparent window or a semi-transparent window on the model screen in a manner which allows the model screen to perform display.

7. The CAE analysis navigation system according to claim 6, wherein the menu screen is separably provided on the model screen.

8. A computer readable CAE analysis processing program stored in a plurality of terminal apparatuses interconnected via a communication network, an analysis procedure of CAE analysis applied in common to a common analysis object being successively performed by the plurality of terminal apparatuses, simultaneously and in association with each other, wherein
the analysis procedure includes an analysis object model producing step, a mesh refining step, a material selecting step, a condition setting step of setting a condition, depending on analysis contents, and an analysis performing step, and further, a step of transmitting processing information to the other terminal apparatuses to have in common a process of each of the steps among the terminal apparatuses, and a step of reflecting processing information transmitted from the other terminal apparatuses in a process of the self apparatus.

9. The CAE analysis processing program according to claim 8, wherein support information about an analysis task corresponding to each of the steps is possessed in common among the terminal apparatuses.

10. A computer readable recording medium recording the CAE analysis processing program according to claim 8.
